(19) United States
(12) Patent Application Publication
(10) Pub. No.: US 2018/0321640 A1
(43) Pub. Date: Nov. 8, 2018

(54) WEARABLE APPARATUS AND DISPLAY METHOD

(71) Applicant: SEIKO EPSON CORPORATION, Tokyo (JP)

(72) Inventor: Kazuhiro MIYOSHI, Matsumoto-shi (JP)

(73) Assignee: SEIKO EPSON CORPORATION, Tokyo (JP)

(21) Appl. No.: 15/944,016

(22) Filed: Apr. 3, 2018

(30) Foreign Application Priority Data
May 2, 2017 (JP) 2017-091623

(51) Int. Cl. G04B 47/06; G04G 21/02; G06F 3/041

(52) U.S. Cl. CPC G04B 47/063; G06F 3/0412; G06F 3/0416; G04G 21/025

(57) ABSTRACT

A wearable apparatus includes at least one sensor that measures a user's activity, a processor that generates activity information at a plurality of points of time based on data measured with the at least one sensor, a display that displays the activity information, and a bezel that is disposed along a circumferential edge of the display and outputs an operation signal corresponding to an operation of the user. The processor also causes the display to display the activity information corresponding to a selected one of the plurality of points of time based on the operation signal.

### RELATED APPLICATIONS

This application claims priority to Japanese Patent Application No. 2017-091623, filed May 2, 2017. The disclosure of this prior application is hereby incorporated by reference in its entirety.

### BACKGROUND

### 1. Technical Field

The present invention relates to a wearable apparatus and a display method.

### 2. Related Art

There is a known wristwatch-shaped wearable apparatus of related art that is worn on a wrist or any other site with the aid of a band or any other component and has the function of measuring the wearer's (user's) exercise or any other activity and determining the amount of calorie and other factors associated therewith. As a wearable apparatus of this type, JP-A-6-180379 discloses a consumed calorie calculation device that uses the principle of a circular calculating scale, allows the wearer (user) to perform operation of calculating the product of the exerciser's (user's) weight and an exercise period, and shows the calorie consumed in the exercise on an exercise type basis in a position having a certain relation to the position representing the product.

The consumed calorie calculation device disclosed in JP-A-6-180379, however, requires the user to be accustomed to reading the markings of the calculating scale and is therefore not a device that allows anyone to readily recognize a measured value. Further, the user of a wearable apparatus of this type frequently desires to grasp how the result of an activity changes, but it is difficult for the consumed calorie calculation device to allow the user to readily check the history of the result of the activity. It has therefore been desired to develop a wearable apparatus that allows a wearer (subject) who is the user of the apparatus to readily check results of measurement of an exercise and other activities including a consumed calorie and how the results change.

### SUMMARY

An advantage of some aspects of the invention is to solve at least a part of the problems described above, and the invention can be implemented as the following forms or application examples.

### Application Example 1

A wearable apparatus according to this application example includes at least one sensor that measures a user's activity, a processor that generates activity information at a plurality of points of time based on data measured with the at least one sensor, a display that displays the activity information, and a bezel that is disposed along a circumferential edge of the display and outputs an operation signal corresponding to an operation of the user, and the processor causes the display to display the activity information corresponding to a selected one of the plurality of points of time based on the operation signal.

The wearable apparatus according to this application example causes the display to display, out of activity information at a plurality of points of time generated based on data on the user's activity measured with the at least one sensor, activity information corresponding to a selected one of the plurality of points of time based on the operation signal corresponding to the user's operation of the bezel, whereby the user can readily grasp the activity information corresponding to the selected point of time. In other words, the user can readily check the history of the activity information corresponding to a desired point of time (selected point of time) by operating the bezel.

### Application Example 2

A wearable apparatus according to this application example includes at least one sensor that measures a user's activity, a processor that generates activity information at a plurality of points of time based on data measured with the at least one sensor, a display that displays the activity information, and a touch sensor that outputs an operation signal corresponding to an operation of the user, and the processor causes the display to display the activity information corresponding to a selected one of the plurality of points of time based on the operation signal.

The wearable apparatus according to this application example causes the display to display, out of activity information at a plurality of points of time generated based on data on the user's activity measured with the at least one sensor, activity information corresponding to a selected one of the plurality of points of time based on the operation signal corresponding to the user's operation of the touch sensor, whereby the user can readily grasp the activity information corresponding to the selected point of time. In other words, the user can readily check the history of the activity information corresponding to a desired point of time (selected point of time) by operating the touch sensor.

### Application Example 3

It is preferable that the processor of the wearable apparatus according to the application example described above further acquires target information on a target of the user's activity, and that the processor causes the display to display progress information calculated based on the operation signal by using the activity information corresponding to the selected point of time and the target information.

According to this application example, the user can readily check the progress information with respect to a target and calculated based on the operation signal by using the activity information corresponding to the selected point of time and the target information by looking at the display.

### Application Example 4

In the wearable apparatus according to the application example described above, it is preferable that the display has a first area and a second area different from the first area, and that the processor causes the display to display the activity information in the first area and causes the display to display at least one of the progress information and the activity information corresponding to the selected point of time in the second area.

According to this application example, the configuration in which the display area where the activity information is displayed and the area where at least one of the progress information and the selected point of time is displayed are separate from each other allows enhancement of the visibility of the displayed information. Further, the display aspects in the first area and the second area are allowed to differ from each other. The user can therefore readily check the displayed contents, for example, even during an exercise.

### Application Example 5

In the wearable apparatus according to the application example described above, it is preferable that the plurality of points of time correspond to laps in the user's activity.

According to this application example, since the plurality of points of time correspond to the laps in the user's activity, the user can readily grasp the activity information corresponding to each of the laps. In other words, the user can readily check the history of the activity information corresponding to a desired lap by operating the bezel.

### Application Example 6

In the wearable apparatus according to the application example described above, it is preferable that the processor calculates comparison information on a result of comparison between the target information and the activity information at the selected point of time and causes the display to display the comparison information.

According to this application example, the user can readily check comparison information displayed on the display and representing the result of the comparison between the target information and the activity information at the selected point of time. In other words, the user can check the situation of the user's activity at each selected point of time, that is, the performance of the user's activity, the degree of progress of the activity, and other factors, while comparing the situation with the target at the selected point of time.

### Application Example 7

In the wearable apparatus according to the application example described above, it is preferable that the processor adds a note to the activity information and causes the display to display the activity information associated with the note in the first area.

According to this application example, selective display of the activity information to which the note has been added (activity information associated with note) can be selectively displayed in the first area, whereby the user can obtain information that the user desires to know additionally and information that is important to the user.

### Application Example 8

In the wearable apparatus according to the application example described above, it is preferable that the plurality of points of time include a first point of time and a second point of time that follows the first point of time, that when the bezel is rotated in a first direction, the selected point of time moves from the second point of time to the first point of time, and that when the bezel is rotated in a second direction, which is opposite the first direction, the selected point of time moves from the first point of time to the second point of time.

According to this application example, a method for selecting a selected point of time can be readily changed based on the rotation direction of the bezel. That is, when the bezel is rotated in the first direction, the point of time can be so selected that the selected point of time moves from the second point of time to the first point of time, whereas when the bezel is rotated in the second direction, the point of time can be so selected that the selected point of time moves from the first point of time to the second point of time.

### Application Example 9

A display method according to this application example includes generating activity information at a plurality of points of time based on data on a user's activity measured with a sensor of a wearable apparatus and causing a display of the wearable apparatus to display the activity information corresponding to a selected one of the plurality of points of time based on an operation signal outputted in correspondence with operation of rotating a bezel of the wearable apparatus.

The display method according to this application example causes the display to display, out of activity information at a plurality of points of time generated based on data on the user's activity measured with the sensor, activity information corresponding to a selected one of the plurality of points of time based on the operation signal corresponding to the user's operation of the bezel. The method, which is readily performed, allows the user to readily grasp the activity information corresponding to the selected point of time. Further, the user can readily check the history of the activity information corresponding to a desired point of time (selected point of time) by operating the bezel.

### Application Example 10

A display method according to this application example includes generating activity information at a plurality of points of time based on data on a user's activity measured with a sensor of a wearable apparatus and causing a display to display the activity information corresponding to a selected one of the plurality of points of time based on an operation signal outputted in correspondence with operation of a touch sensor of the wearable apparatus.

The display method according to this application example causes the display to display, out of activity information at a plurality of points of time generated based on data on the user's activity measured with the sensor, activity information corresponding to a selected one of the plurality of points of time based on the operation signal corresponding to the user's operation of the touch sensor. The method, which is readily performed, allows the user to readily grasp the activity information corresponding to the selected point of time. Further, the user can readily check the history of the activity information corresponding to a desired point of time (selected point of time) by operating the touch sensor.

### BRIEF DESCRIPTION OF THE DRAWINGS

The invention will be described with reference to the accompanying drawings, wherein like numbers reference like elements.

FIG. 1 is a schematic configuration diagram showing an overview of an exercise assistance system.

FIG. 2 is an exterior view showing a schematic configuration of a wearable apparatus used in the exercise assistance system.

FIG. 3 is an exterior view showing an example of the worn wearable apparatus.

FIG. 4 is a cross-sectional view showing the configuration of an apparatus body of a wearable apparatus according to a first embodiment.

FIG. 5 is an enlarged cross-sectional view of a portion Q shown in FIG. 4.

FIG. 6 is a block diagram showing an example of the functional configuration of the wearable apparatus according to the first embodiment.

FIG. 7 is a plan view showing the configuration of an optical pattern for detection of the rotation of a rotary bezel.

FIG. 8 diagrammatically shows a detection signal produced when the optical pattern is read.

FIG. 9 is a flowchart showing a display method performed by the wearable apparatus according to the first embodiment.

FIG. 10 is a plan view showing a display procedure 1 performed by the wearable apparatus according to the first embodiment.

FIG. 11 is a plan view showing a display procedure 2 performed by the wearable apparatus according to the first embodiment.

FIG. 12A is a plan view showing a display example 1 resulting from operation of the rotary bezel.

FIG. 12B is a plan view showing the display example 1 resulting from operation of the rotary bezel.

FIG. 12C is a plan view showing the display example 1 resulting from operation of the rotary bezel.

FIG. 13A is a plan view showing a display example 2 resulting from operation of the rotary bezel.

FIG. 13B is a plan view showing the display example 2 resulting from operation of the rotary bezel.

FIG. 13C is a plan view showing the display example 2 resulting from operation of the rotary bezel.

FIG. 14A is a plan view showing a display example 3 resulting from operation of the rotary bezel.

FIG. 14B is a plan view showing the display example 3 resulting from operation of the rotary bezel.

FIG. 14C is a plan view showing the display example 3 resulting from operation of the rotary bezel.

FIG. 15 is a plan view showing the configuration of an apparatus body of a wearable apparatus according to a second embodiment.

FIG. 16 is a cross-sectional view showing the configuration of the apparatus body of the wearable apparatus according to the second embodiment.

FIG. 17 is a block diagram showing an example of the functional configuration of the wearable apparatus according to the second embodiment.

FIG. 18 is a flowchart showing a display method performed by the wearable apparatus according to the second embodiment.

FIG. 19 is a plan view showing a variation of the display method.

### DESCRIPTION OF EXEMPLARY EMBODIMENTS

An exercise assistance system (exercise assistance device), an exercise assistance method, and an exercise assistance program according to embodiments of the invention will be described below. It is not intended that the embodiments described below unduly limit the contents of the invention set forth in the appended claims. Further, all configurations described in the embodiments are not necessarily essential configuration requirements of the invention.

### 1. Approach in Present Embodiment

The exercise assistance system according to an embodiment of the invention will first be described. In the following description, a wearable apparatus worn, for example, on a user's wrist and including a biological sensor, a body motion sensor, a position sensor, and other sensors will be described as an example of a detection device used in the exercise assistance system.

The wearable apparatus in the present specification will be described with reference to a wearable apparatus worn on a wrist, but a wearable apparatus according to each embodiment may instead be worn on the user's another site, such as the neck or the ankle. An exercise assistance device and an exercise assistance system according to each embodiment may include a biological sensor other than a photoelectric sensor.

### 2. Exercise Assistance System

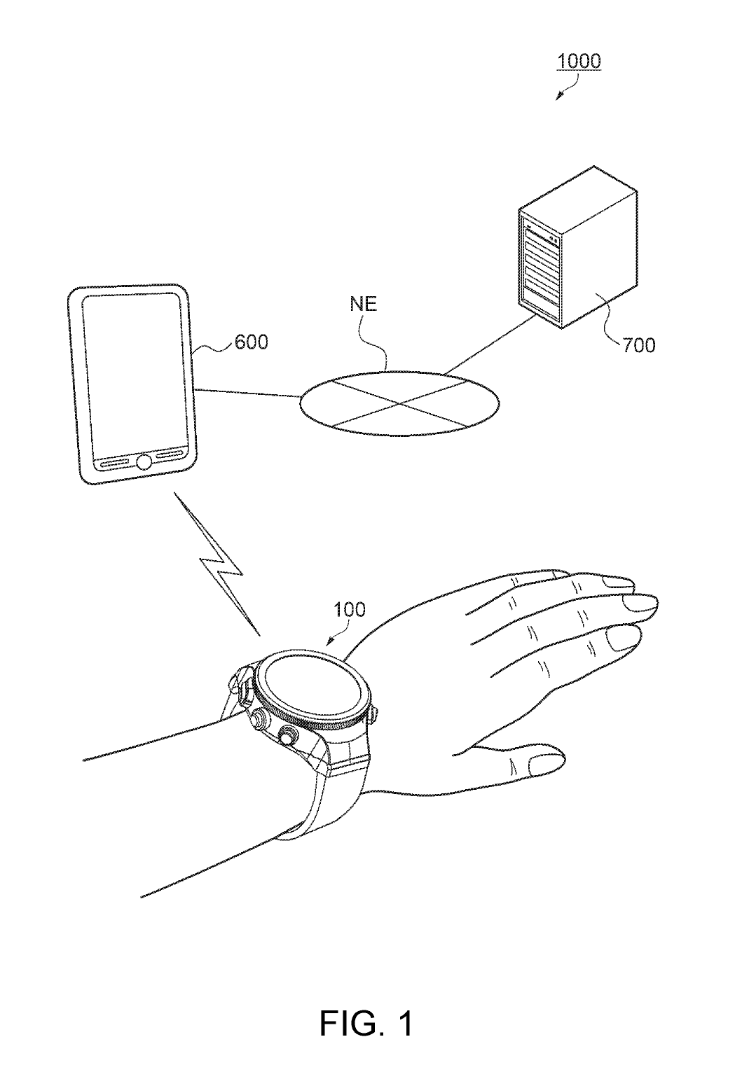

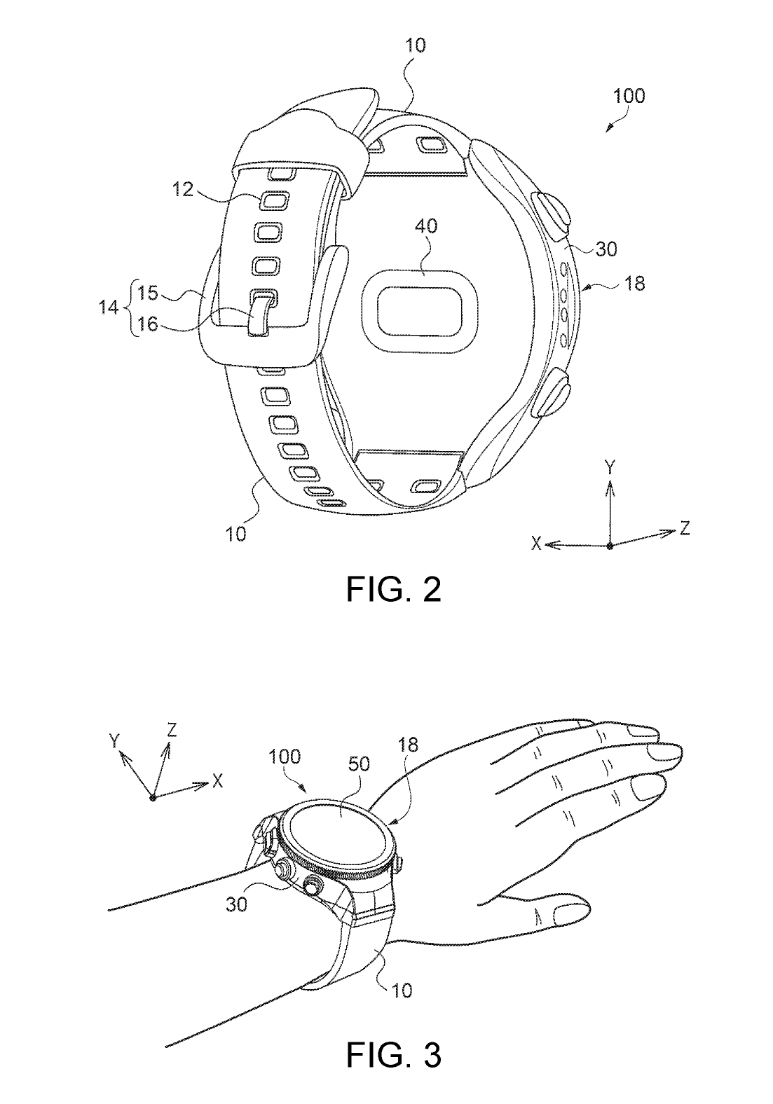

The configuration of the exercise assistance system according to an embodiment of the invention will next be described with reference to FIGS. 1, 2, and 3. FIG. 1 is a schematic configuration diagram showing an overview of the exercise assistance system. FIG. 2 is an exterior view showing a schematic configuration of the wearable apparatus used in the exercise assistance system. FIG. 3 is an exterior view showing an example of the worn wearable apparatus.

An exercise assistance system 1000 according to the present embodiment includes a wearable apparatus 100, a portable terminal device 600 as an exercise assistance device, and an information processing device 700 connected to the portable terminal device 600 over a network NE, as shown in FIG. 1.

The portable terminal device 600 can be formed, for example, of a smartphone or a tablet-type terminal device. The portable terminal device 600 is connected to the wearable apparatus 100 over short-distance wireless communication, wired communication, or any other type of communication (not shown). The portable terminal device 600 can be connected to the information processing device 700, such as a PC (personal computer) and a server system, over the network NE. The network NE can be a WAN (wide area network), a LAN (local area network), short-distance wireless communication, or any of a variety of other networks. In this case, the information processing device 700 is achieved in the form of a processor/storage that receives over the network NE and stores pulse wave information, body motion information, position information, and other pieces of information measured by the wearable apparatus 100.

The wearable apparatus 100 only needs to be capable of communicating with the portable terminal device 600 and does not need to be directly connected to the network NE. The configuration of the wearable apparatus 100 can therefore be simplified. It is, however, noted that as a variation of the exercise assistance system 1000, the portable terminal device 600 can be omitted, and the wearable apparatus 100 can be directly connected to the information processing device 700. In this configuration, information measured by the wearable apparatus 100 can be directly transmitted to the information processing device 700, and the wearable apparatus 100 can receive a result of analysis performed by the information processing device 700, whereby the user's convenience can be improved.

The exercise assistance system 1000 is not necessarily achieved by the information processing device 700. For example, the exercise assistance system 1000 may be achieved by the portable terminal device 600. For example, the portable terminal device 600, such as a smartphone, is subject to constraints, such as the processing performance, the storage area, and the battery capacity, as compared with a server system, but it is believed that sufficient processing performance and the like can be ensured in consideration of improvement in performance in recent years. Therefore, as long as the processing performance and other requirements are satisfied, the portable terminal device 600 can be the exercise assistance system 1000 according to the present embodiment.

Further, the exercise assistance system 1000 is not necessarily achieved by one device. For example, the exercise assistance system 1000 may include at least two of the wearable apparatus 100, the portable terminal device 600, and the information processing device 700. In this case, a process carried out by the exercise assistance system 1000 may be carried out by any one of the devices described above or may be carried out in a distributed manner by a plurality of the devices described above. Further, the exercise assistance system 1000 according to the present embodiment can include any apparatus other than the wearable apparatus 100 as the detection device, the portable terminal device 600 as the exercise assistance device, and the information processing device 700.

Further, in consideration of improvement in the performance of a terminal device, usage of a terminal device, and other factors, the exercise assistance system 1000 (portable terminal device 600) according to the present embodiment can be achieved by the wearable apparatus 100.

A process carried out by each portion of the exercise assistance system 1000 according to the present embodiment can be achieved by a program. That is, the approach in the present embodiment is applicable to a program that causes a computer to carry out the process of performing a variety of types of analysis based on activity information generated from the user's activity data measured with the variety of sensors at a plurality of points of time, a user inputted target of the exercise, and other factors in the user's exercise and the process of displaying the results of the variety of types of analysis.

The activity information is measured data or activity data associated with time information. Specifically, the activity information includes a travel distance, an accumulated distance, a travel period, an accumulated period, a travel speed, a pitch (number of steps per minute), the number of steps, the pace, and other factors. The activity information may instead be information on a statistic of the activity performed by the user in a predetermined period with the statistic associated with the time information. Specific examples of the activity information may include the lap time, which is the period required per unit distance (1 km, for example), the pitch, which is the number of steps per minute, the average speed and maximum speed in a lap segment (unit period or unit distance), and the average and maximum pulse rates in a lap segment.

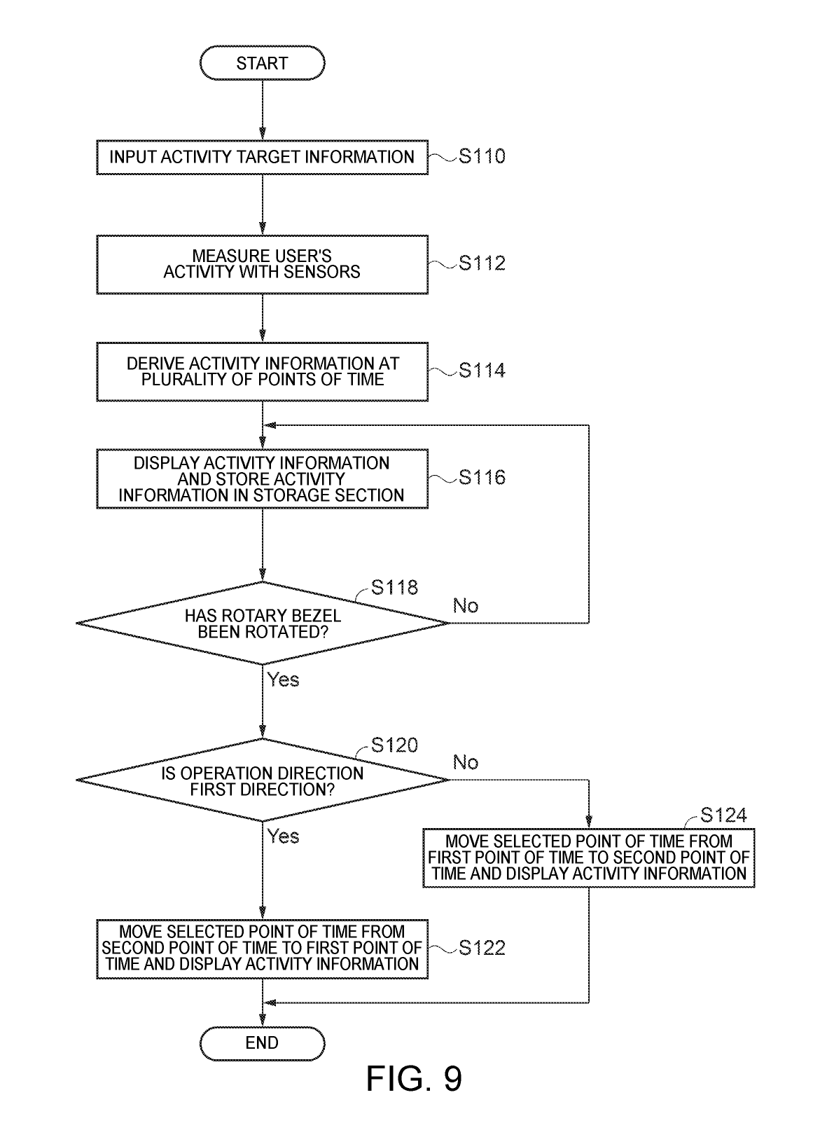

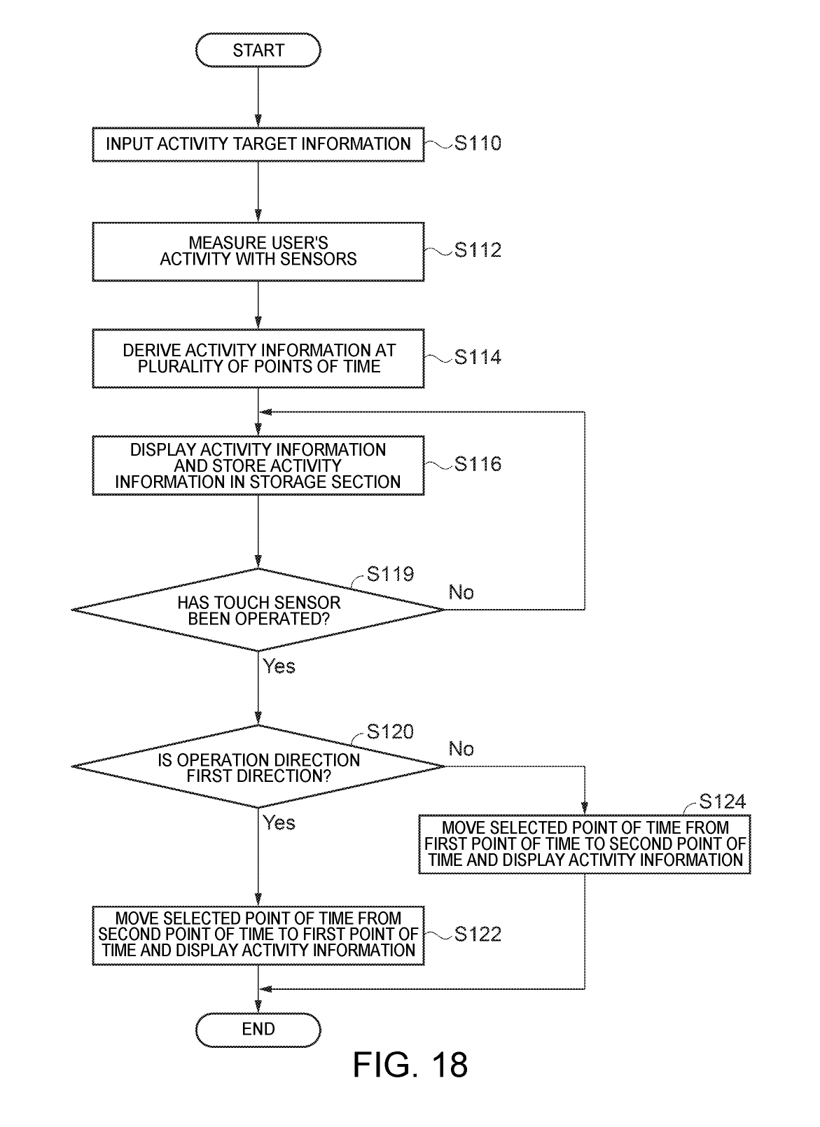

The program can perform, for example, the following computation and notification. More specifically, a program according to the present embodiment can cause a computer to carry out the steps shown in FIGS. 9 and 18, which will be described later.

1) A user inputted target value of activity information on an exercise is acquired. Examples of the target value may include the exercise distance and exercise period per workout, the exercise distance and exercise period per week or month, the number of laps, which is the number of measurement unit segments (one circuit, one round trip, for example), the lap time, which is the period required per unit distance (1 km, for example), the pitch, which is the number of steps per minute, the number of steps and consumed calorie per day, and the sleeping hours.

2) In the user's exercise, activity information generated from data on the user's activity measured with a sensor at a plurality of points of time is acquired, displayed, and stored. The plurality of points of time can correspond to the number of laps in the user's activity, may correspond to elapsed periods, or may correspond to specific points of time, such as workouts in a race period.

3) Activity information corresponding to a selected point of time (specific lap) selected from the plurality of points of time (plurality of laps, for example) is displayed based on an output signal from a bezel section (rotary bezel), a touch panel, or any other portion operated by the user. That is, when a series of exercises ends, or when an exercise is suspended, for example, after one race ends, activity information corresponding to the selected lap based on the user's operation can be extracted from stored information and displayed.

4) Based on the output signal from the bezel section (rotary bezel), the touch panel, or any other portion operated by the user, the activity information corresponding to a selected point of time (specific lap) selected from the plurality of points of time (plurality of laps, for example) and the user inputted target value of the activity information are used to calculate progress information and display the progress information.

The exercise assistance system 1000 according to the present embodiment further includes a memory that stores information (programs and a variety of pieces of data, for example) and a processor that operates based on the information stored in the memory. The processor may, for example, be so configured that the functions of the portions of the exercise assistance system 1000 are achieved by individual pieces of hardware or the functions of the portions are achieved by integrated hardware. The processor may, for example, be a CPU. It is, however, noted that the processor is not limited to a CPU and can, for example, be a GPU (graphics processing unit), a DSP (digital signal processor), or any of a variety of other processors. The processor may still instead be an ASIC-based hardware circuit. The memory may, for example, be an SRAM (static random access memory), a DRAM (dynamic random access memory), or any other semiconductor memory, a register, a hard disk drive or any other magnetic storage, or an optical disk drive or any other optical storage. For example, the memory stores computer readable instructions, and the functions of the portions of the exercise assistance system 1000 are achieved when the processor executes the instructions. The instructions may each be an instruction in a set of instructions that form the program or an instruction that instructs a hardware circuit in the processor to operate.

The wearable apparatus 100 is worn on a given site of the user's body (wrist or any other target to be measured, for example), as shown in FIGS. 2 and 3, and detects biological information, body motion information, and other pieces of information. The wearable apparatus 100 includes an apparatus body 18, which includes a case section 30, comes into intimate contact with the user's body, and detects biological information, body motion information, and other pieces of information, and a pair of band sections 10, which are attached to the apparatus body 18 and allow the apparatus body 18 to be worn on the user's body. The apparatus body 18 including the case section 30 is provided with a display section 50 and a biological sensor section 40. The band sections 10 are provided with fitting holes 12 and a buckle 14. The buckle is formed of a buckle frame 15 and a locking section (protruding rod) 16.

In the following description of the wearable apparatus 100, when the apparatus body 18 is worn on the user, the measured target (subject) side of the apparatus body 18 is called “a rear side or a rear surface side,” and the display surface side of the apparatus body 18, which is the side opposite the measured target side, is called “a front side or a front surface side.” A measured “target” is called a “subject” in some cases. A coordinate system is set with respect to the case section 30 of the wearable apparatus 100, and the display surface of the display 50 is called the front surface. Under the definition described above, the direction that intersects the display surface of the display 50 and extends from the rear surface toward the front surface is called a Z-axis positive direction. Instead, the direction extending from the biological sensor section 40 toward the display section 50 or the direction away from the case section 30 along a normal to the display surface of the display section 50 may be defined as the Z-axis positive direction. In the state in which the wearable apparatus 100 is worn on a subject, the Z-axis positive direction described above corresponds to the direction from the subject toward the case section 30. Further, two axes perpendicular to the Z axis are called X and Y axes, and the Y axis, in particular, is so set to coincide with the direction in which the band sections 10 are attached to the case section 30.

FIG. 2 is a perspective view of the wearable apparatus 100, with the band sections 10 fixed by using one of the fitting holes 12 and the locking section 16, viewed in the −Z-axis direction or from the side facing the band sections 10 (subject-side surface out of surfaces of case section 30 in state in which wearable apparatus 100 is worn). The wearable apparatus 100, in which the band sections 10 have the plurality of fitting holes 12, is worn on the user by inserting the locking section 16 of the buckle 14 into any of the plurality of fitting holes 12. The plurality of fitting holes 12 are provided along the longitudinal direction of the band sections 10.

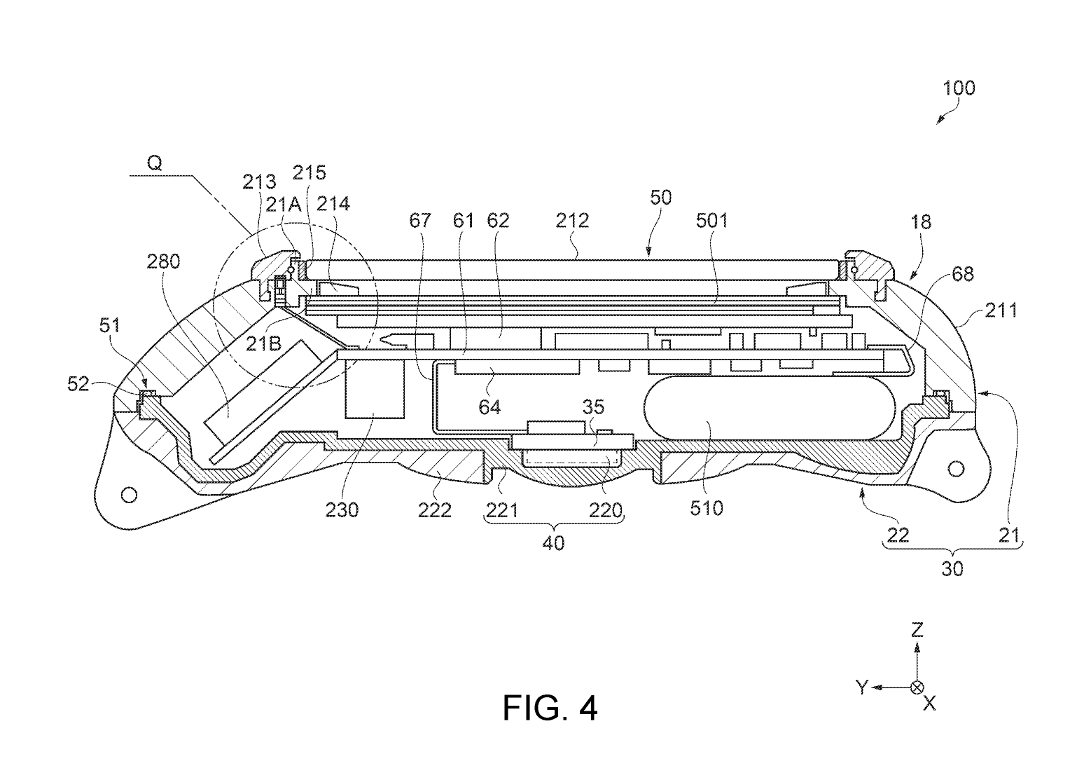

On the assumption that biological sensors (pulse wave sensor 220 (see FIG. 4), which acquires pulse wave information, a skin temperature sensor, blood pressure sensor, blood sugar level sensor, SpO₂ sensor, and skin potential sensor) are provided, FIG. 2 shows a case where the biological sensor section 40 is provided on a surface of the case section 30 or the surface facing the subject when the wearable apparatus 100 is worn. The position where the biological sensor section 40 is provided is not limited to the position shown, for example, in FIG. 2. For example, the biological sensor section 40 may be provided inside the case section 30.

It is conceivable to employ, for example, an approach in which the pulse wave sensor 220 is, for example, a photoelectric sensor and the photoelectric sensor detects light with which the body has been irradiated and which has been reflected off the body or has passed through the body. In the approach, since the amount of light with which the body is irradiated and which is absorbed by or reflected off the body varies in accordance with the amount of blood in a blood vessel, sensor information detected with the photoelectric sensor is a signal corresponding, for example to the amount of blood, and analysis of the signal allows acquisition of information on the pulse. It is, however, noted that the pulse wave sensor 220 is not limited to a photoelectric sensor and may instead be an electrocardiograph, an ultrasonic sensor, or any other sensor. The body motion sensor is a sensor that detects the user's body motion. The body motion sensor is conceivably, for example, an acceleration sensor or an angular velocity sensor but may be any other sensor. The position sensor is a sensor that senses information on the position of the user and information on the environment in which the user is present. The position sensor is conceivably, for example, a GPS (global positioning system), an orientation sensor, an atmospheric pressure sensor, or a temperature sensor but may be any other sensor.

FIG. 3 shows the wearable apparatus 100 worn on the user and viewed from the side where the display section 50 is provided (in Z-axis direction). The wearable apparatus 100 according to the present embodiment includes the display section 50 in a position corresponding to the dial of a typical wristwatch or a position where numerals and icons are visually recognizable, as shown in FIG. 3. In the state in which the wearable apparatus 100 is worn, a second case member 22 (see FIG. 4) of the case section 30 is in intimate contact with the subject, and the display section 50 is so located as to be readily visually recognized by the user.

### 3. Embodiments of Wearable Apparatus

### First Embodiment

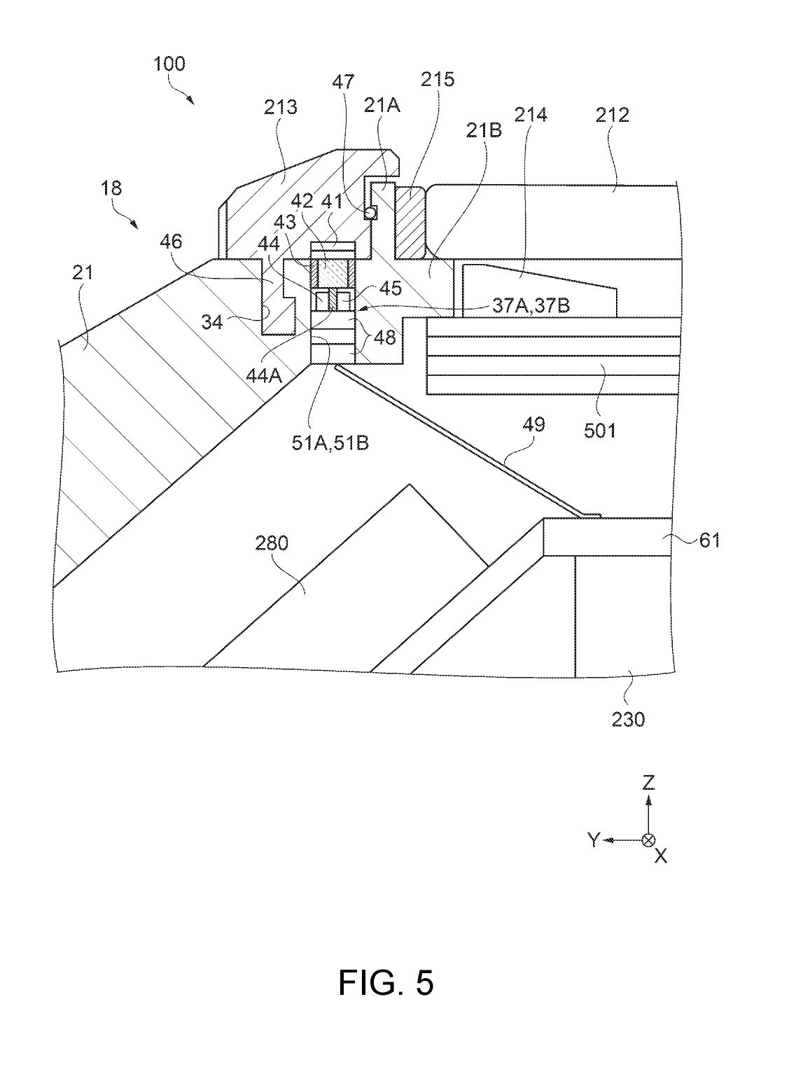

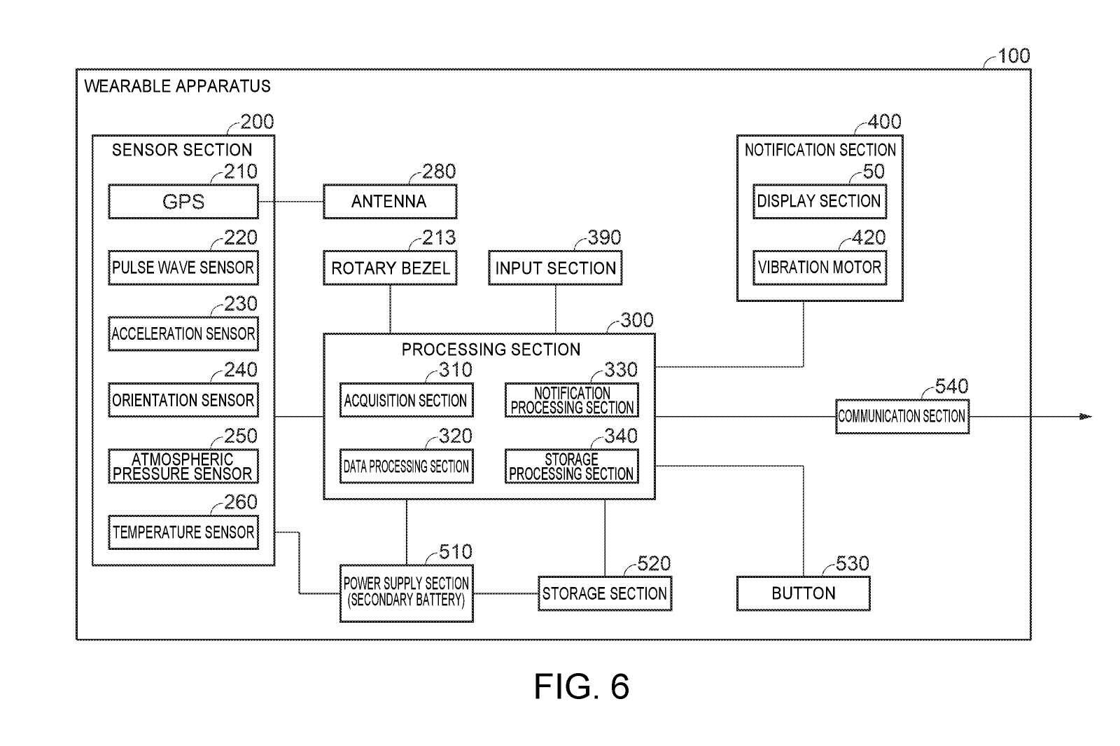

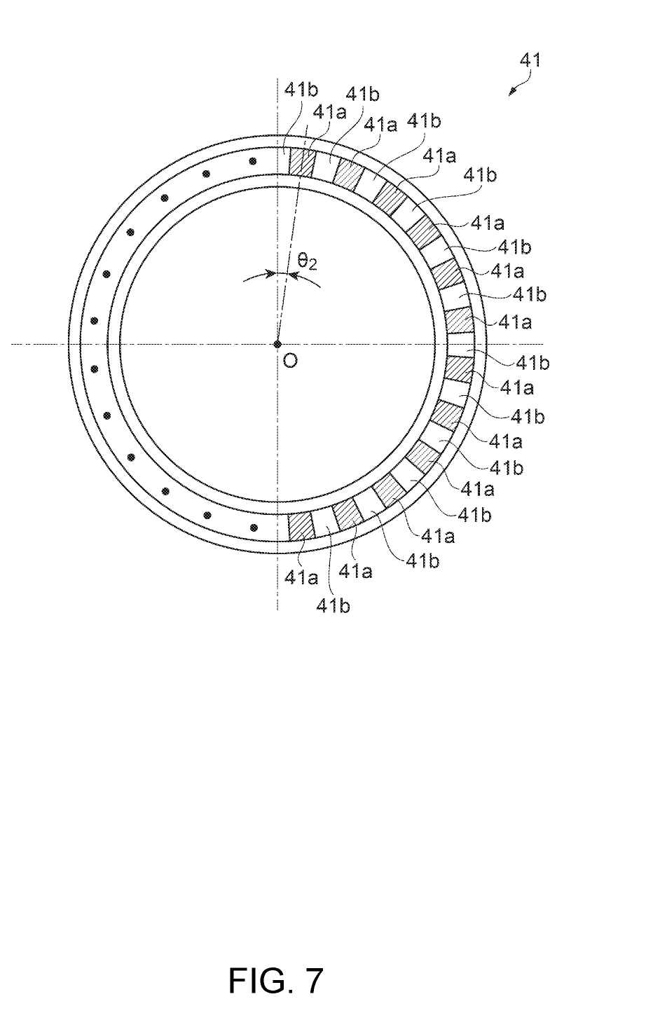

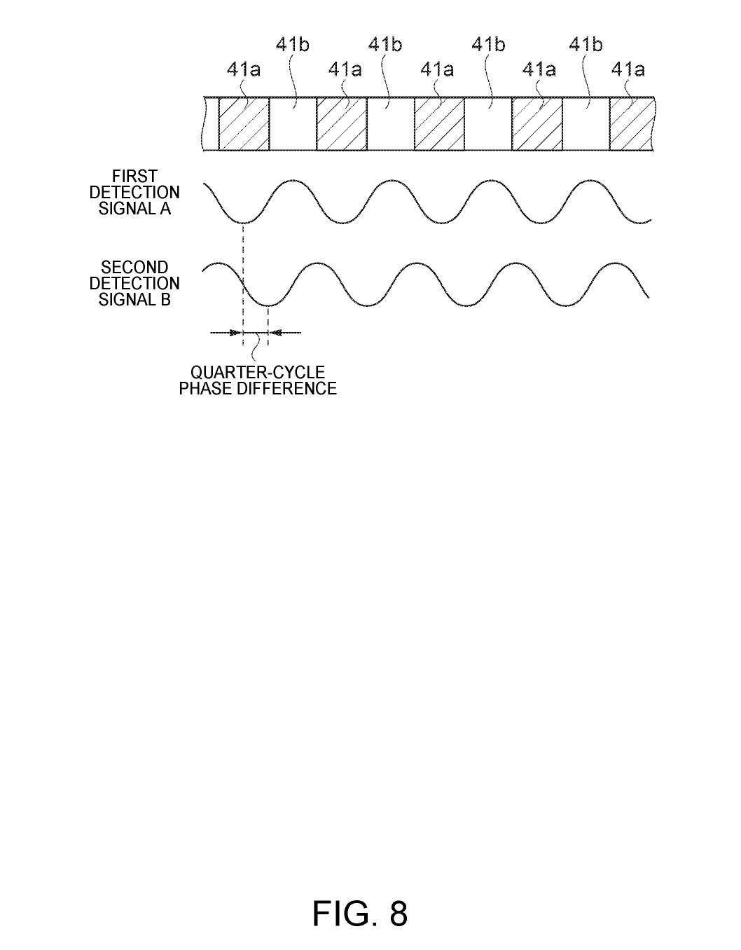

The configuration of a wearable apparatus according to a first embodiment of the invention will next be described in detail with reference to FIGS. 4, 5, 6, 7, and 8. FIG. 4 is a cross-sectional view showing the configuration of the apparatus body of the wearable apparatus according to the first embodiment. FIG. 5 is an enlarged cross-sectional view of a portion Q shown in FIG. 4. FIG. 6 is a block diagram showing an example of the functional configuration of the wearable apparatus according to the first embodiment. FIG. 7 is a plan view showing the configuration of an optical pattern for detection of the rotation of the rotary bezel. FIG. 8 diagrammatically shows a detection signal produced when the optical pattern is read.

The apparatus body 18, which forms the wearable apparatus 100, includes the case section 30, which includes a first case member (top case) 21, which is located on the front side, and a second case member (bottom case) 22, which is located on the rear side, as shown in FIG. 4. The second case member 22 is located on the side facing the target under measurement when the apparatus body 18 is worn on the user. The first case member 21 is disposed, relative to the second case member 22, on the side opposite the target under measurement (front side). A detection window 221 is provided in the rear surface of the second case member 22, and the biological sensor section 40 is provided in the second case member 22 in the position corresponding to the detection window 221.

The apparatus body 18 includes, in addition to the first case member 21 and the second case member 22, a module substrate 35, the biological sensor section 40 connected to the module substrate 35, a circuit substrate 61, a panel frame 62, a circuit case 64, a liquid crystal display (hereinafter referred to as LCD 501) that forms the display section 50, an acceleration sensor 230 as an example of the body motion sensor, a secondary battery 510 as a power supply section, and a GPS antenna 280. It is, however noted that the configuration of the wearable apparatus 100 is not limited to the configuration shown in FIG. 4, and another configuration can be added, and part of the configuration can be omitted.

The first case member 21 may include a barrel section 211 and a glass plate 212. A ring-shaped wall section 21A, which protrudes toward the front side, and a protruding section 21B, which protrudes inward, are provided in a front-side upper portion of the barrel section 211 of the first case member 21. The glass plate 212 is mounted on the front side of the protruding section 21B and connected and fixed to the inner circumferential surface of the wall section 21A, for example, via an adhesive member 215. In this case, the barrel section 211 and the glass plate 212 may be configured to be used as an outer wall that protects the internal structure and to allow the user to view information displayed on the display section 50, such as the LCD 501, provided immediately below the glass plate 212 via the glass plate 212. That is, in the present embodiment, the LCD 501 may be used to display a variety of pieces of information, such as detected biological information, activity information representing the state of an exercise, or time information, and the displayed information may be presented to the user on the side facing the first case member 21. In the present embodiment, the LCD 501 is so disposed as to be in contact with the rear side of the protruding section 21B.

A parting plate 214 in the form of a ring member provided between the glass plate 212 (windshield glass pate) and the LCD 501 can be disposed along an outer edge portion of the glass plate 212. The case where a top plate portion of the wearable apparatus 100 is achieved by the glass plate 212 is presented in the description, and the top plate portion can instead be formed of a transparent member made, for example, of a material other than glass, such as a transparent plastic material as long as the transparent member allows the LCD 501 to be viewed and is strong enough to be capable of protecting the LCD 501 and other configurations accommodated in the case section 30.

A rotary bezel 213, which serves as the bezel section, is disposed outside the outer circumference of the glass plate 212 of the first case member 21 and along the outer edge of the glass plate 212, in other words, along the circumferential edge of the display section 50. The rotary bezel 213 is a ring-shaped (annular) member that surrounds the glass plate 212 and is so disposed as to be slidable relative to the first case member 21, whereby the rotary bezel 213 is rotatable roughly around the center of the glass plate 212. The rotary bezel 213 can be formed of a member made, for example, of stainless steel or brass and having a plated surface. The configuration of the rotary bezel 213 will be described below in detail with reference to FIG. 5.

The “bezel section” in the present specification is used as a collective name of the function of the bezel of what is called a wristwatch and a functional portion that outputs an operation signal. That is, in the present specification, the rotary bezel 213 represents a configuration having the function of the bezel of a wristwatch combined with a functional portion including an optical pattern 41, which outputs an operation signal when the bezel section is operated (moved) as will be described later, a first sensor unit 37A, a second sensor unit 37B, and other components, and the rotary bezel 213 may therefore be called a rotary operation section.

A circumferential groove 34 is provided in a front-side upper portion of the first case member 21, as shown in FIG. 5. On the other hand, a projection 46, which protrudes toward the rear side, is formed on the lower surface of the rotary bezel 213, and the projection 46 is slidably fit into the groove 34. An 0 ring 47 is provided at the surface where the side surface of the rotary bezel 213 is in contact with the first case member 21, and the 0 ring 47 prevents water, light, and the like from entering the interior of the wearable apparatus 100 through the gap between the rotary bezel 213 and the first case member 21.

A circumferential, bottomed groove is provided in a surface of the rotary bezel 213 or the surface facing the first case member 21, and the optical pattern 41 for detecting the rotation of the rotary bezel 213 is disposed in the groove. The first case member 21 is provided with two holes 51A and 51B in positions facing the optical pattern 41, and the first sensor unit 37A and the second sensor unit 37B are disposed in the holes 51A and 51B, respectively. The first sensor unit 37A and the second sensor unit 37B have the same configuration, and the hole 51A and the first sensor unit 37A, which is disposed in the hole 51A, will be representatively described below.

A cover glass plate 42 is disposed in the hole 51A, which faces the optical pattern 41. A gasket 43 is disposed between the first case member 21 and the cover glass plate 42 and prevents water and the like from entering the interior of the first case member 21 via the cover glass plate 42.

The first sensor unit 37A is disposed on the side opposite the optical pattern 41 with respect to the cover glass plate 42. The first sensor unit 37A includes an LED (light emitting diode) 44, a photodiode 45, a light blocking plate 44A, and a substrate 48. The LED 44 radiates light toward the optical pattern 41, and the photodiode 45 receives the light reflected off the optical pattern 41. The light blocking plate 44A prevents the photodiode 45 from directly receiving the light from the LED 44 and is disposed between the LED 44 and the photodiode 45. The substrate 48 produces a detection signal in accordance with the amount of light received with the photodiode 45 and outputs the detection signal to a processing section 300 (see FIG. 6), which will be described later. Further, a lead wire 49 is provided on the rear side of the substrate 48 of the first sensor unit 37A, and the lead wire 49 electrically connects the first sensor unit 37A to the circuit substrate 61.

In the configuration described above, the amount of rotation (that is, angle of rotation) of the rotary bezel 213 and the direction of the rotation thereof (rotational speed as required) are detected based on the detection signals outputted by the first sensor unit 37A and the second sensor unit 37B. A principle of the detection of the rotation of the rotary bezel 213 will be described below with reference to FIGS. 7 and 8. FIG. 7 shows the configuration of the optical pattern 41, and FIG. 8 diagrammatically shows the detection signals outputted from the first sensor unit 37A and the second sensor unit 37B when they read the optical pattern 41.

The optical pattern 41, which is formed in the groove in the lower surface of the rotary bezel 213, has a configuration in which a light absorbing area 41a, which absorbs the light radiated by the LED 44 (see FIG. 5), and a light reflecting area 41b, which reflects the light from the LED 44, are alternately and repeatedly arranged along the circular path, as shown in FIG. 7. In the configuration, the line segment extending from the center of each of the light absorbing areas 41a or the light reflecting areas 41b to the center of rotation O of the rotary bezel 213 and the line segment extending from the center of the adjacent light absorbing area 41a or light reflecting area 41b to the center of rotation O is θ2. That is, to detect the rotation of the rotary bezel 213 described above in the unit of 360° divided by n (n is even number), θ2 is equal to 360°/n. In this configuration, when the user rotates the rotary bezel 213, the first sensor unit 37A alternately reads the light absorbing areas 41a and the light reflecting areas 41b of the optical pattern 41 shown in FIG. 7 and outputs a detection signal having a roughly sinusoidal waveform, such as that shown in FIG. 8, (hereinafter referred to as “first detection signal A”). The second sensor unit 37B similarly outputs a detection signal having the roughly sinusoidal waveform (hereinafter referred to as “second detection signal B”).

In the first embodiment, an angle θ1 is so set to satisfy the following expression: θ1=θ2+θ2/2, and the first sensor unit 37A and the second sensor unit 37B are disposed in accordance with the angle θ1. As a result, when the user rotates the rotary bezel 213, the first detection signal A produced by the first sensor unit 37A and the second detection signal B produced by the second sensor unit 37B have a quarter-cycle phase difference. Specifically, when the rotary bezel 213 is rotated clockwise, the second detection signal B produced by the second sensor unit 37B advances by the quarter-cycle phase with respect to the first detection signal A produced by the first sensor unit 37A, as shown in FIG. 8. Conversely, when the rotary bezel 213 is rotated counterclockwise, the second detection signal B produced by the second sensor unit 37B delays by the quarter-cycle phase with respect to the first detection signal A produced by the first sensor unit 37A. Sensing the phase delay/advance allows detection of the direction of the rotation of the rotary bezel 213.

The second case member 22 is provided with a biological information detecting section, and in the case where the pulse wave sensor 220, the blood pressure sensor, the blood sugar level sensor, the SpO₂ sensor, and other sensors are used, the biological information detecting section is provided with the detection window 221 and a bank section 222, as shown in FIG. 4. The bank section 222 rises from the second case member 22 along the direction toward the subject, and the detection window 221 is provided in the bank section 222. The biological sensor section 40 is provided in the position corresponding to the detection window 221. The detection window 221 is configured to rise along the direction toward the subject and transmit light, and light emitted from a light emitter (not shown) provided in the pulse wave sensor 220 passes through the detection window 221 and impinges on the subject. The light reflected off the subject also passes through the detection window 221 and is received with a light receiver (not shown) in the pulse wave sensor 220. That is, providing the detection window 221 allows biological information to be detected by using a photoelectric sensor. The pulse wave sensor 220 is connected to the module substrate 35. The module substrate 35 is electrically connected to the circuit substrate 61, for example, via a flexible substrate 67. Although not shown, in the case where the skin potential sensor, the temperature sensor, and other sensors are used, a measurement electrode is disposed in the biological information detecting section in the bottom case 22.

The circuit substrate 61 has one surface on which the panel frame 62, which guides a display panel, such as the LCD 501, is disposed and the other surface on which the circuit case 64, which guides the secondary battery 510 and other components is disposed. On the circuit substrate 61 are mounted elements that forma circuit that drives the pulse wave sensor 220 to measure the pulse, a circuit that drives the acceleration sensor 230 to detect body motion, a circuit that processes satellite signals from the GPS antenna 280 to produce position information, a circuit that drives the LCD 501, a circuit that controls the circuits described above, and other circuits. The circuit substrate 61 is electrically continuous with the electrodes of the LCD 501 via a connector that is not shown. The LCD 501 displays measured data on the pulse, such as the pulse rate, information on an activity, such as an exercise, time information, such as the current time, and other pieces of information in accordance with each mode.

The case section 30 accommodates the rechargeable secondary battery 510 (lithium secondary battery) as a power supply section. The secondary battery 510, the positive and negative terminals of which are connected to the circuit substrate 61, for example, via a connection substrate 68, supplies electric power to a circuit that controls the electric power. The electric power is converted by the circuit into predetermined voltage or otherwise processed and supplied to the circuits described above to operate the circuit that drives the pulse wave sensor 220 to detect the pulse, the circuit that drives the acceleration sensor 230 to detect body motion, the circuit that processes satellite signals from the GPS antenna 280 to produce position information, the circuit that drives the LCD 501, the circuit that controls the circuits described above, and other circuits. The secondary battery 510 is charged via a pair of charge terminals electrically continuous with the circuit substrate 61 via members that allow electrical continuity (not shown), such as coil springs. The description has been made with reference to the case where the secondary battery 510 is used as a battery. The battery may instead be a primary battery, which does not need to be recharged.

The detection window 221 may be so formed as to extend to a sealing section 51, which is provided at a portion where the first case member 21 and the second case member 22 are connected to each other, as shown in FIG. 4. The sealing section 51 may be provided with a gasket 52, which seals the interior of the case section 30 to isolate it from the outside. The gasket 52 is provided in the portion where the first case member 21 and the second case member 22 are connected to each other and seals the interior of the case section 30 to isolate it from the outside.

The wearable apparatus 100 includes, as examples of the functional configuration thereof, a sensor section 200, the rotary bezel 213, the GPS antenna 280, a processing section 300, an input section 390, a notification section 400, the secondary battery 510 as the power supply section, a storage section 520, a button 530, and a communication section 540, as shown in FIG. 6.

The sensor section 200 includes a variety of sensors that acquire and measure information on the user's activity. The sensor section 200 in the present embodiment includes a GPS 210, the pulse wave sensor 220, an acceleration sensor 230, an orientation sensor 240, an atmospheric pressure sensor 250, and a temperature sensor 260. The sensor section 200 can further include a skin temperature sensor, a blood pressure sensor, a blood sugar level sensor, an SpO₂ sensor, and a skin potential sensor.

The GPS 210 is connected to the GPS antenna 280 and can perform positioning calculation based on a plurality of satellite signals received via the GPS antenna 280 to acquire the user's position information and movement information.

The pulse wave sensor 220 detects the user's pulse and other factors. The pulse wave sensor 220 is formed, for example, of a photoelectric sensor. The subject (target under measurement) is irradiated with light outputted from the pulse wave sensor 220, and the pulse wave sensor 220 can receive the light reflected off the subject to detect pulse information. The pulse wave sensor 220 can output the detected signal as a pulse wave detection signal or a pulse detection signal.

The acceleration sensor 230 and the orientation sensor 240 can detect information on the user's body motion, that is, body motion information. The acceleration sensor 230 and the orientation sensor 240 each sense the user's body motion and output a body motion detection signal that is a signal that changes in accordance with the body motion.

The atmospheric pressure sensor 250 can detect the atmospheric pressure in the user's current position. The atmospheric pressure sensor 250 measures the atmospheric pressure in the current position and outputs the measured atmospheric pressure as atmospheric pressure data. The atmospheric pressure data acquired with the atmospheric pressure sensor 250 can be used to forecast a change in the weather and acquire information on the altitude (height above sea level) in the user's current position. Providing the atmospheric pressure sensor 250 allows the altitude information (information on height above sea level) at the location where the user is present to be presented to the user, whereby the wearable apparatus 100 can be provided as a device suitable, for example, for a mountain climber and a hiker.

The temperature sensor 260 can detect the temperature (ambient temperature) in the user's current position. The temperature sensor 260 measures the temperature (ambient temperature) in the current position and outputs the measured temperature as temperature data. The temperature (ambient temperature) data acquired with the temperature sensor 260 can be used to forecast a change in the weather and a change in the temperature (change in ambient temperature).

The rotary bezel 213 has not only the function of the bezel of a wristwatch but the functional portion that outputs an operation signal when the user operates (moves) the bezel. The rotary bezel 213 outputs an operation signal corresponding to the user's operation of the bezel. Based on the operation signal outputted when the user operates the rotary bezel 213, the processing section 300 can change the display aspect in accordance with which the display section 50 performs display operation. In the present embodiment, the light-detection-type detection method using the optical pattern 41, the first sensor unit 37A, and the second sensor unit 37B, as the configuration of the operation signal outputting functional portion of the rotary bezel 213, is presented by way of example, but not necessarily. For example, a capacitance-detection-type detection method for detecting a change in the capacitance between two portions facing each other and outputting an operation signal and any other configuration may be used.

The processing section 300 uses, for example, the storage section 520 as a work area to perform a variety of types of signal processing and carry out control processes and can be achieved, for example, by a CPU or any other processor or an ASIC or any other logic circuit. The processing section 300 includes an acquisition section 310, a data processing section 320, a notification processing section 330, and a storage processing section 340. The processing section 300 processes a variety of types of data outputted, for example, from the GPS 210, the pulse wave sensor 220, the acceleration sensor 230, the orientation sensor 240, the atmospheric pressure sensor 250, and the temperature sensor 260 to calculate and store the user's activity information. The processing section 300 can cause the display section 50 to display the activity information at a selected point of time selected from a plurality of activity points of time based on the operation signal outputted when the user operates the rotary bezel 213.

The processing section 300 can add a note to the calculated activity information and cause the display section 50 to display the activity information associated with the added note in a first area AR1 (see FIG. 10), which will be described later. Since the display operation described above allows selective display of the activity information to which the note has been added (activity information associated with note) on the display section 50, the user can obtain information that the user desires to know additionally and information that is important to the user.

The acquisition section 310 acquires activity (exercise) target information inputted by the user, for example, via the input section 390 or the button 530, for example, target information, such as a lap time target set in a race that the user participates.

The data processing section 320 processes a variety of pieces of data outputted, for example, from the GPS 210, the pulse wave sensor 220, the acceleration sensor 230, the orientation sensor 240, the atmospheric pressure sensor 250, and the temperature sensor 260 to calculate information on the user's activity at a plurality of points of time. Further, the data processing section 320 uses activity information corresponding to a selected point of time (specific lap) selected from a plurality of points of time (plurality of laps, for example) and the activity information target value inputted by the user to calculate progress information based on the output signal from the rotary bezel 213 operated by the user. The progress information can contain information on comparison between the activity information and the activity information target value. Further, the data processing section 320 can save the calculated activity information at the plurality of points of time in the storage section 520 and read the stored activity information from the storage section 520 and can cause the notification processing section 330 to convert the activity information into notification data, such as display data.

The notification processing section 330, based on the user's activity information calculated by the data processing section 320 at the plurality of points of time and the output signal from the rotary bezel 213 operated by the user, converts the activity information and progress information corresponding to a selected point of time (specific lap) selected from the plurality of points of time (plurality of laps, for example) into notification data, such as display data and vibration data, instructs the notification section 400 to issue notification, and performs other types of control.

The storage processing section 340 saves (stores) the user's activity information and progress information and other pieces of data calculated by the data processing section 320 at the plurality of points of time and other pieces of data in the storage section 520. The storage processing section 340 further reads the activity information, the progress information, and other pieces of data saved (stored) in the storage section 520 in response to an instruction from the data processing section 320 and transmits the read data to the data processing section 320.

The input section 390 allows input of activity (exercise) target information, for example, target information, such as a lap time target set in a race that the user participates. The input section 390 can be an input terminal connected to another apparatus.

The notification section 400 notifies the user of a variety of pieces of information under the control of the notification processing section 330. The notification section 400 includes the display section 50, which is formed, for example, of a liquid crystal display and displays an image. The notification section 400 causes the display section 50 to display the user's activity information in the form of an image based, for example, on a data signal from the notification processing section 330. As another notification method, the notification section 400 can use vibration produced, for example, by a vibration motor (vibrator) 420 or may include a notification light emitter (not shown) formed of an LED or any other component. A variety of pieces of information can be notified to the user in the form of the intensity, length, or any other parameter of vibration in the case where the vibration motor 420 is used and in the form of the light-on state, blinking state, or any other state of light in the case where the notification light emitter is used. The variety of information described above may be notified only in the form of an image or in combination of an image and at least one of the vibration and the light emitted for notification.

The rechargeable secondary battery 510, which serves as the power supply section, supplies the circuits in the wearable apparatus 100 with electric power after the electric power is converted by the circuit that controls electric power into predetermined voltage. The electric power allows operation of the circuits in the wearable apparatus 100, for example, the circuit that drives the pulse wave sensor 220 to detect the pulse and the circuit that controls the circuits in the wearable apparatus 100.

The storage section 520 stores the user's activity information calculated by the data processing section 320 at a plurality of points of time or the activity information and the progress information corresponding to a selected point of time (specific lap) selected from the plurality of points of time (plurality of laps, for example) based on the output signal from the rotary bezel 213 operated by the user. The storage section 520 further stores a program that causes a computer to carry out a series of processes to be carried out in the exercise assistance system 1000 according to the present embodiment. The storage section 520 can be formed, for example, of an SRAM (static random access memory), a DRAM (dynamic random access memory), or any other semiconductor memory, a hard disk drive or any other magnetic storage, or an optical disk drive or any other optical storage.

The button 530 can be disposed on the side surface of the apparatus body 18 and can, for example, switch a display mode in accordance with which the display section 50 performs display operation, start and stop displaying measured time, correct the time, and perform other types of operation.

The communication section 540 carries out a communication process of transmitting a notification signal controlled by the notification processing section 330 to a notification functional portion provided, for example, in another terminal apparatus. In this case, wireless communication according to Bluetooth (registered trademark) or any other standard can be used without use of the network NE. The notification signal to be transmitted in this case can, for example, be an image signal, a vibration signal, or a light emission signal. The communication section 540 can be connected to the information processing device 700, such as a PC or a server system, over the network NE shown in FIG. 1.

### Display Method Performed by Wearable Apparatus According to First Embodiment

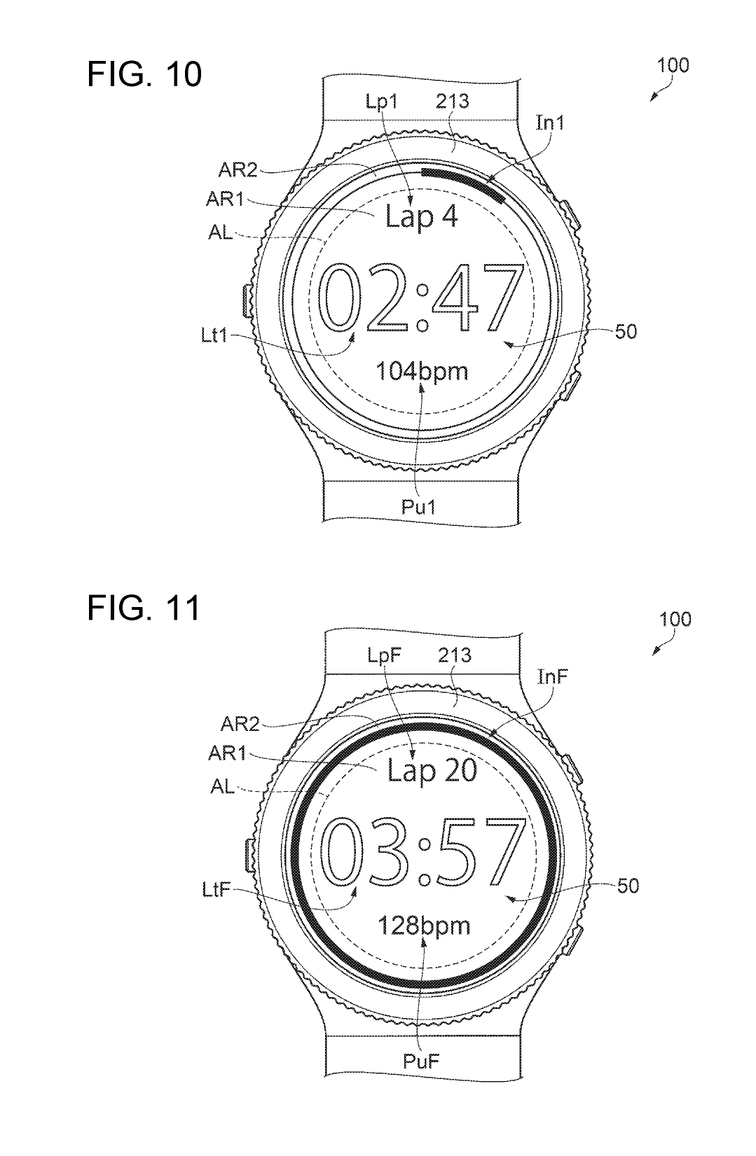

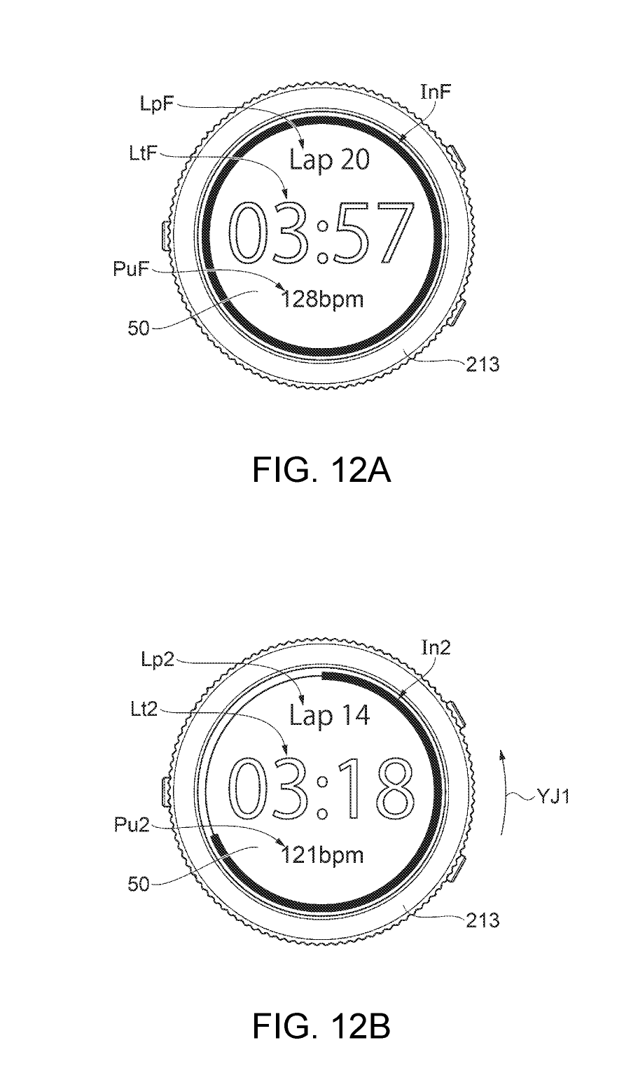

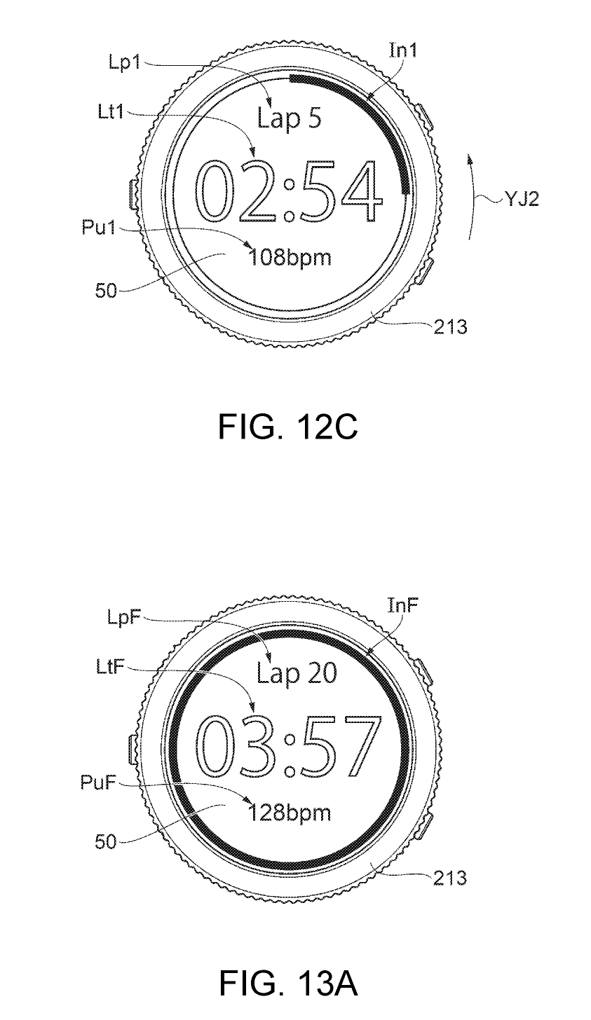

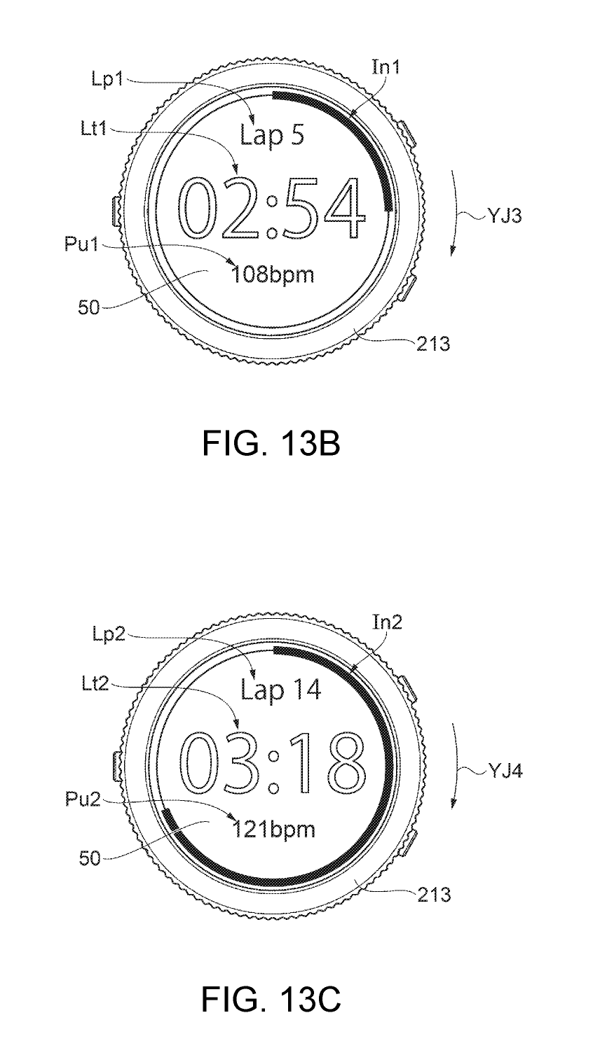

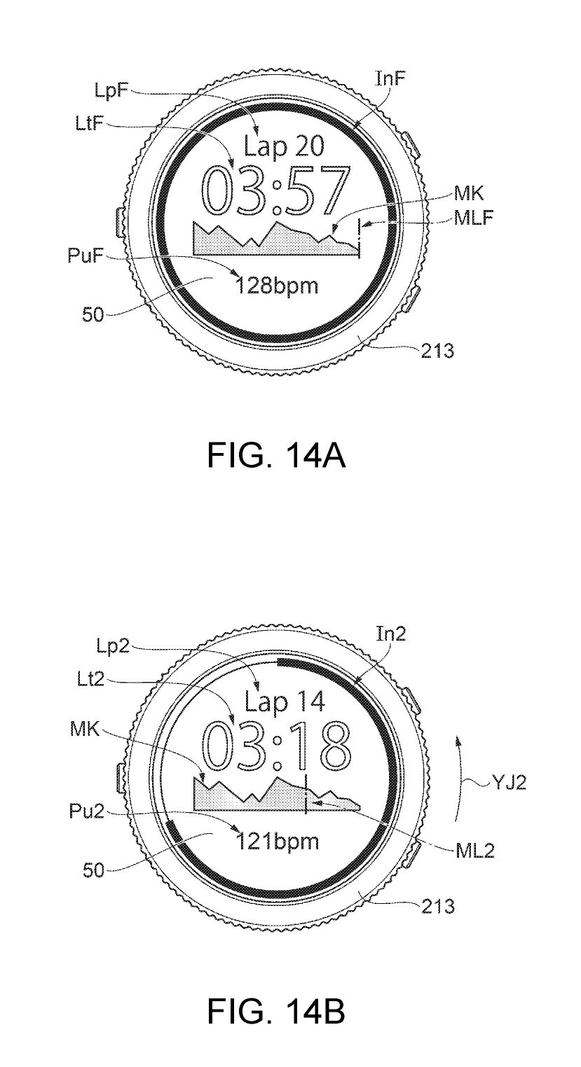

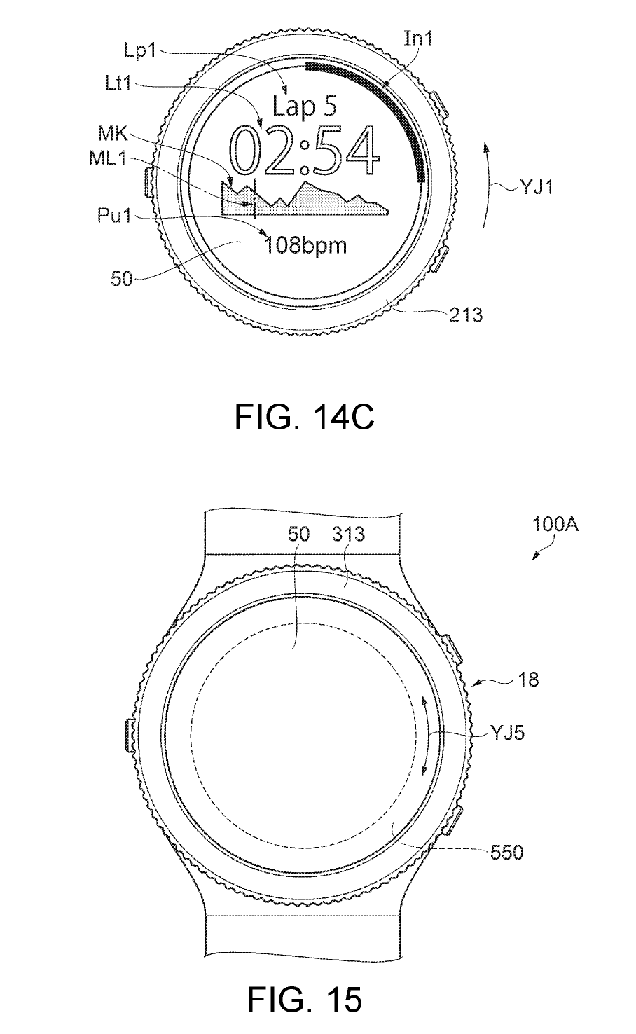

A display method performed by the wearable apparatus 100 according to the first embodiment will next be described with reference to FIGS. 9, 10, 11, 12A to 12C, 13A to 13C, and 14A to 14C. FIG. 9 is a flowchart showing the display method performed by the wearable apparatus according to the first embodiment. FIG. 10 is a plan view showing a display procedure 1 performed by the wearable apparatus according to the first embodiment. FIG. 11 is a plan view showing a display procedure 2 performed by the wearable apparatus according to the first embodiment. FIGS. 12A, 12B, and 12C are plan views showing a display example 1 resulting from operation of the rotary bezel. FIGS. 13A, 13B, and 13C are plan views showing a display example 2 resulting from operation of the rotary bezel. FIGS. 14A, 14B, and 14C are plan views showing a display example 3 resulting from operation of the rotary bezel.

The display method performed by the wearable apparatus 100 according to the first embodiment will be described below with reference to FIG. 9. The display method performed by the wearable apparatus 100 includes step S110 of inputting target information, step S112 of measuring an activity, step S114 of generating activity information, step S116 of displaying and storing the activity information, step S118 of checking whether the rotary bezel 213 has been operated, step S120 of checking the direction in which the rotary bezel 213 has been operated, and steps S122 and S124 of displaying the activity information at a selected point of time. The procedure in each of the steps will be described below. The following description of the procedures uses the same reference characters used in the description of the configuration of the exercise assistance system 1000 described above.

The user first inputs activity (exercise) target information, for example, target information, such as a target lap time set by the user in a race that the user participates, as activity (exercise) preparation information via the input section 390 (see FIG. 6) of the wearable apparatus 100 (step S110). The step S110 can be omitted in a case where the purpose of using the wearable apparatus 100 is not comparison with a target but checking of the history of a race.

The user then starts the activity (exercise). The sensors disposed in the wearable apparatus 100 each perform measurement or sensing in accordance with the function thereof (step S112). Data measured or sensed with each of the sensors is outputted to the processing section 300. The processing section 300 processes the data inputted by the data processing section 320 to generate user's activity information at a plurality of points of time (step S114). The processes in steps S112 and S114 are continuously carried out to the point of time when a series of activities (exercises) ends unless the user issues an instruction.

The processing section 300 successively displays the generated user's activity information and data at the plurality of points of time on the display section 50 under the control of the notification processing section 330 and successively saves (stores) the activity information and data in the storage section 520 under the control of the storage processing section 340 (step S116).

An exemplary aspect of the display operation will be described with reference to FIGS. 10 and 11. FIG. 10 shows an example of displayed progress information at the time of a lap 4 out of the user's activity information at the plurality of points of time displayed on the display section 50 of the wearable apparatus 100. FIG. 11 shows an example of information displayed on the display section 50 at the point of time when the series of activities (exercises) ended, for example, at the point of time when the race that the user participated ended (finish point). In the examples shown in FIGS. 10 and 11, it is assumed that the number of laps in the race is 20 (20 laps).

The display section 50 of the wearable apparatus 100 is divided by a broken line AL shown in FIGS. 10 and 11 into a first area AR1, which is a central area, and a second area AR2, which is outside the broken line AL (on the side facing the rotary bezel 213), as shown in FIGS. 10 and 11. The first area AR1 successively displays the user's activity information (progress information) at the point of time “Lap 4” or “Lap 10.” In the present example, the first area AR1 displays the following pieces of information: the number of the lap at the point of time is displayed in an upper portion; the lap time at the point of time is displayed in a central portion; and the average pulse rate at the point of time is displayed in a lower portion. The second area AR2 displays a ring-shaped indicator that displays the point of time in a visual form.

FIG. 10 shows an example of displayed activity information (progress information) at the point of time “lap 4” selected as the displayed point of time. In the present example, “Lap 4” is displayed as the number of the lap Lp1 at the point of time “Lap 4” in the upper portion, “02:47 (2 minutes and 47 seconds)” is displayed as the lap time Lt1 at the point of time “Lap 4” is displayed in the central portion, and “104 bpm” is displayed as the average pulse rate Pu1 at the point of time “Lap 4” in the lower portion. The second area AR2 displays a ring-shaped indicator that displays the point of time in a visual form. In the present example, to indicate “lap 4,” which is the displayed selected point of time, an indicator line In1 is so displayed as to extend to the angle corresponding to one turn (360°) multiplied by 4 laps divided by 20 laps. The displayed point of time is successively incremented and displayed as the activity progresses, for example, “lap 4” followed by “lap 5” and “lap 5” followed by “lap 6.” The plurality of points of time to be displayed correspond to the number of laps in the user's activity.

FIG. 11 shows an example of displayed activity information at the end of the series of activities (exercises) selected as the points of time to be displayed, for example, at the point of time when the race that the user participated ended (finish point). In the present example, “Lap 20” is displayed as the number of the lap LpF at the point of time of the end of the race in the upper portion, “03:57 (3 minutes and 57 seconds)” is displayed as the lap time LtF at the point of time “Lap 20” in the central portion, and “128 bpm” is displayed as the average pulse rate PuF at the point of time “Lap 20” in the lower portion. The second area AR2 displays the ring-shaped indicator, which displays the point of time in a visual form. In the present example, to indicate “lap 20” at the point of time of the end of the race, the indication line InF is so displayed as to fully extend along the circumference.

The configuration in which the display area where activity information is displayed (first area AR1) and the area where a selected point of time is displayed (second area AR2) are separate from each other as described above allows enhancement of the visibility of the displayed information. Further, the display aspects in the first area AR1 and the second area AR2 are allowed to differ from each other. The user can therefore readily check the displayed contents, for example, even during an exercise.

A note may be added to activity information, and the activity information associated with the added note may be displayed in the first area AR1 of the display section 50. The display operation described above allows the user to visually recognize the activity information to which a note has been added (activity information associated with note) on the display section 50, whereby the user can selectively obtain information that the user desires to know and information that is important to the user. To add a note, for example, a note selected or inputted based on the user's button operation may be added to activity information, or the processing section may associate a predetermined note with activity information based thereon. Examples of the note may include letter information, such as a sentence and a comment, an image, such as an icon and a photograph, voice, and numerals.

Referring back to the flowchart of FIG. 9, the processing section 300 evaluates whether or not the user has rotated the rotary bezel 213 (step S118). In other words, the processing section 300 evaluates whether or not an operation signal has been outputted in correspondence with operation of rotating the rotary bezel 213. In a case where the result of the evaluation in step S118 shows that the rotary bezel 213 has been rotated (Yes in step S118), the processing section 300 proceeds to the following step and evaluates whether or not the rotation direction of the rotary bezel 213 is the first direction (step S120). In a case where the result of the evaluation in step S118 shows that the rotary bezel 213 has not been rotated (No in step S118), the processing section 300 returns to the preceding step S116.

In a case where the result of the evaluation in step S120 shows that the rotation direction of the rotary bezel 213 is the first direction (Yes in step S120), the processing section 300 selects a selected point of time in such a way that it moves from a second point of time that follows a first point of time to the first point of time and displays the activity information at the selected point of time after the selection, that is, information on the history of the activity information (step S122).

The display operation in this case (step S122) will be described as a display example 1 with reference to FIGS. 12A to 12C. In the display example 1, it is assumed that the point of time when the race started is the lap 1, the first point of time is the lap 5, the second point of time is the lap 14, and the point of time when the race ended (finish point) is the lap 20. First, FIG. 12A shows displayed activity information at the point of time when the series of activities (exercises) ended, for example, at the point of time when the race that the user participated ended (finish point). In a case where the user operates the rotary bezel 213 in such a way that the rotary bezel 213 is rotated counterclockwise (in left-handed direction) to a predetermined angle as indicated by the arrow YJ1 representing the rotation direction, the displayed selected point of time is so successively switched that the time goes back from the point of time when the race ended (finish point) to the point of time when the race started, for example, from the lap 20 through the lap 19, the lap 18, . . . , the lap 14, . . . , the lap 5, . . . , to the lap 1, as shown in FIG. 12B.

In other words, the selected point of time in relation to which activity information is displayed moves from the lap 20, which is the point of time when the race ended (finish point), toward the point of time when the race started, and the activity information (history information) corresponding to the second point of time (lap 14), which follows the first point of time (lap 5), is displayed, as shown in FIG. 12B. Thereafter, the following operation of the rotary bezel 213, such as that shown in FIG. 12C, in detail, counterclockwise (left-handed) rotation in the direction indicated by the arrow YJ2 in FIG. 12C, which is similar to the rotation described above, causes the displayed point of time to move toward the start of the race (start point), and the displayed information is switched to the activity information (history information) corresponding to the first point of time (lap 5), which is ahead of the second point of time. The plurality of displayed points of time thus correspond to the number of laps in the user's activity.

As described above, since a plurality of selected points of time are each displayed in correspondence with the number of the lap in the user's activity, the user can readily grasp the activity information corresponding to the number of the lap. In other words, the user can readily check the history of the activity information corresponding to a desired number of the lap by operating the rotary bezel 213.

In a case where the result of the evaluation in step S120 shows that the rotation direction of the rotary bezel 213 is not the first direction, that is, the rotation direction of the rotary bezel 213 is the second direction (No in step S120), the processing section 300 selects a selected point of time in such a way that it moves from the first point of time to the second point of time, which follows the first point of time, and displays the activity information at the selected point of time after the selection (step S124).

The display operation in this case (step S124) will be described as the display example 2 with reference to FIGS. 13A to 13C. In the display example 2, it is assumed that the point of time when the race started (start point) is the lap 1, the first point of time is the lap 5, the second point of time is the lap 14, and the point of time when the race ended (finish point) is the lap 20, as in the display example 1. First, FIG. 13A shows displayed activity information at the point of time when the series of activities (exercises) ended, for example, at the point of time when the race that the user participated ended (finish point). In a case where the user operates the rotary bezel 213 in such a way that the rotary bezel 213 is rotated clockwise (in right-handed direction) to a predetermined angle as indicated by the arrow YJ3 representing the rotation direction, the displayed selected point of time is so successively switched that the progress of the race is reproduced from the point of time when the race started (start point) toward the point of time when the race ended (finish point), for example, from the lap 1 through the lap 2, the lap 3, the lap 4, the lap 5, . . . , the lap to the lap 20, as shown in FIG. 13B.

In other words, the selected point of time in relation to which the activity information is displayed moves from the lap 1, which is the point of time when the race started (start point), toward the point of time when the race ended (finish point), and the activity information corresponding to the first point of time (lap 5) is displayed, as shown in FIG. 13B. Thereafter, the following operation of the rotary bezel 213, such as that shown in FIG. 13C, in detail, clockwise (right-handed) rotation in the direction indicated by the arrow YJ4 in FIG. 13C, which is similar to the rotation described above, causes the displayed point of time to move toward the end of the race (finish point), and the displayed information is switched to the activity information corresponding to the second point of time (lap 14), which follows the first point of time.

As described above, the method for selecting a selected point of time can be readily changed based on the rotation direction of the rotary bezel 213. That is, when the rotary bezel 213 is rotated in the first direction, the point of time can be so selected that the selected point of time moves from the second point of time to the first point of time, whereas when the rotary bezel 213 is rotated in the second direction, which is opposite the first direction, the point of time can be so selected that the selected point of time moves from the first point of time to the second point of time.

In steps S122 and 124, the direction in which the rotary bezel 213 is operated determines whether the direction in which the point of time to be displayed is selected is the forward or reverse direction. In the display examples 1 and 2, the description has been made with reference to the case where the rotary bezel 213 is rotated in the single direction, but not necessarily, and the rotary bezel 213 may instead be rotated alternately in the right-handed and left-handed directions or in the right-handed and left-handed directions in combination. Also in these cases, the direction in which the point of time to be displayed is selected is switched in accordance with the rotation direction of the rotary bezel 213.

According to the wearable apparatus 100 and the display method performed by the wearable apparatus 100 described above, the display section 50 displays activity information generated based on data on the user's activities measured with the sensors disposed in the wearable apparatus 100 at a plurality of points of time in such a way that activity information corresponding to a selected point of time selected from the plurality of points of time is displayed based on the operation signal corresponding to the user's operation of the rotary bezel 213. The method described above allows the user to readily grasp the activity information corresponding to the selected point of time selected from the plurality of points of time. Further, the user can readily check the history of the activity information corresponding to a desired point of time (selected point of time) by operating the rotary bezel 213.

The display examples in steps S122 and 124 can be replaced with the display aspect in a display example 3 shown in FIGS. 14A to 14C. In the display example 3, in addition to the number of the lap LpF, the lap time LtF, and the average pulse rate PuF as the activity information shown by way of example in FIG. 12A described above, a map mark MK and a final achieved position (finish position) MLF are shown, as shown in FIG. 14A. The map mark MK represents the topography of the place where the activity takes place, and the final achieved position MLF is an indication line shown on the map mark MK and representing the achieved position at the point of time corresponding to the number of the lap LpF. The map mark MK and the final achieved position MLF will be described below with reference to FIGS. 14A to 14C.

In the display example 3, it is assumed that the point of time when the race started (start point) is the lap 1, the first point of time is the lap 5, the second point of time is the lap 14, and the point of time when the race ended (finish point) is the lap 20, as in the display example 1 described above. First, FIG. 14A shows displayed activity information at the point of time when the series of activities (exercises) ended, for example, at the point of time when the race that the user participated ended (finish point). At this point, the indication line shown on the map mark MK and representing the user achieved position is displayed as the final achieved position (finish position) MLF, which is the finish position.

In the case where the user operates the rotary bezel 213 in such a way that the rotary bezel 213 is rotated counterclockwise (in left-handed direction) to a predetermined angle as indicated by the arrow YJ1 representing the rotation direction, the displayed selected point of time is so successively switched that the time goes back from the point of time when the race ended (finish point) to the point of time when the race started, for example, from the lap 20 through the lap 19, the lap 18, . . . , the lap 14, . . . , the lap 5, . . . , to the lap 1, as shown in FIG. 14B. The indication line shown on the map mark MK and representing the user's achieved position is accordingly successively switched to the position ML2 shown in FIG. 14B and further to the position ML1 shown in FIG. 14C.

In other words, the selected point of time, in relation to which the activity information is displayed, moves from the lap 20, which is the point of time when the race ended (finish point) toward the start point, and the activity information corresponding to the second point of time (lap 14), which follows the first point of time (lap 5), is displayed, as shown in FIG. 14B. Thereafter, the following operation of the rotary bezel 213, such as that shown in FIG. 14C, in detail, counterclockwise (left-handed) rotation in the direction indicated by the arrow YJ2 in FIG. 14C, which is similar to the rotation described above, causes the displayed point of time to move toward the start of the race (start point), and the displayed information is switched to the activity information corresponding to the first point of time (lap 5), which is ahead of the second point of time. The same holds true for the case where the rotation direction of the rotary bezel 213 is reversed.

As described above, displaying the map mark MK and the indication line (final achieved position MLF, positions ML1 and ML2) shown on the map mark MK and representing the user's achieved position allows the user to grasp the topography of the place where the activity information corresponding to a selected point of time was produced, for example, whether the activity information was produced when the user ran downhill or uphill, whereby the user can make more proper judgment.

### Second Embodiment

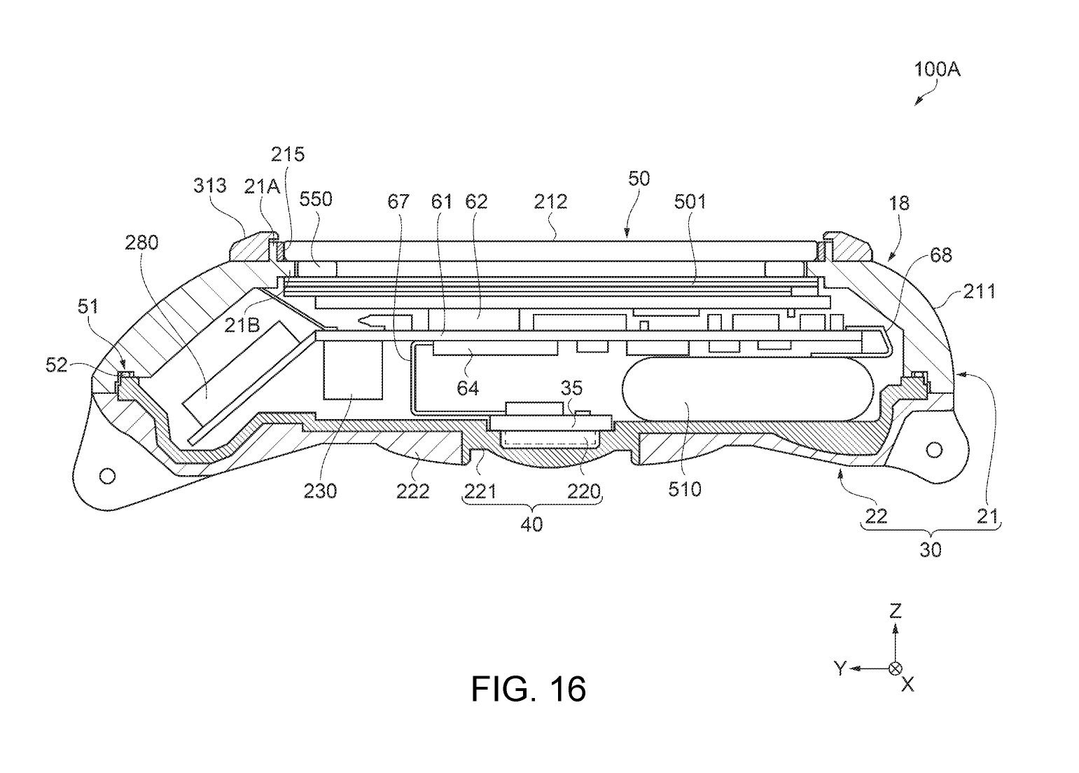

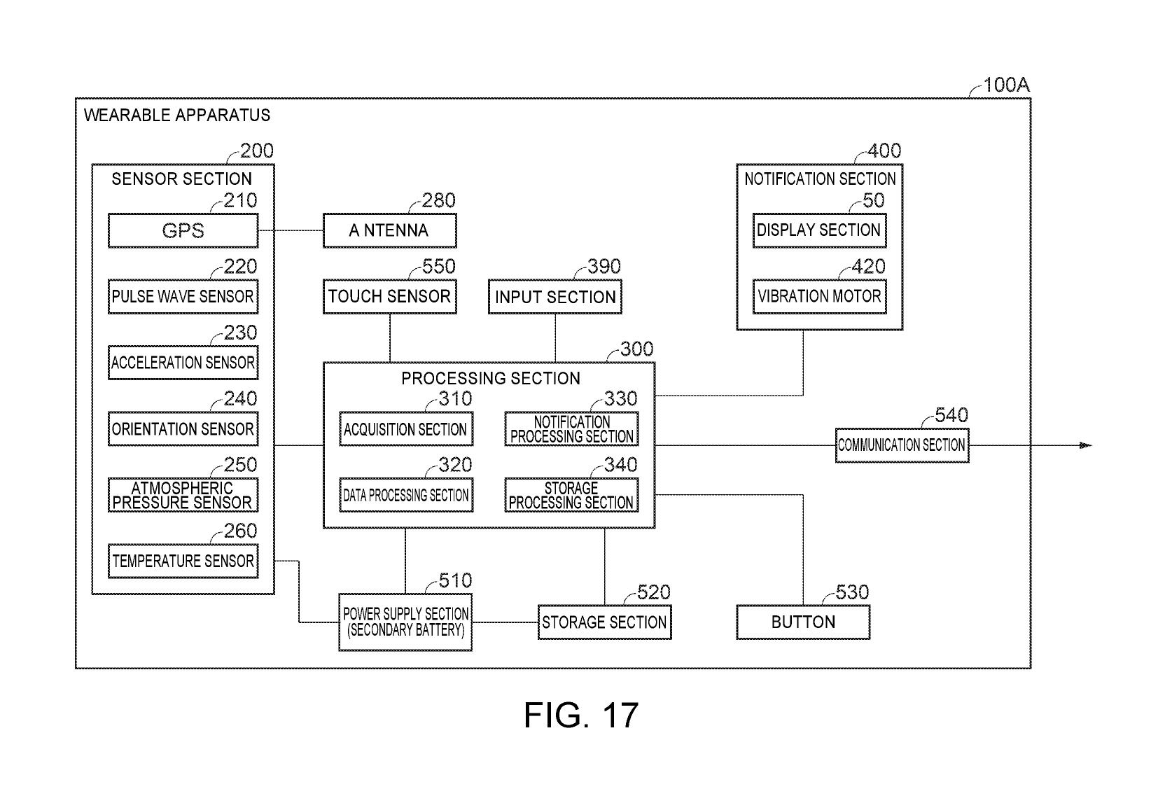

The configuration of a wearable apparatus according to a second embodiment of the invention will next be described in detail with reference to FIGS. 15, 16, and 17. FIG. 15 is a plan view showing the configuration of the apparatus body of the wearable apparatus according to the second embodiment. FIG. 16 is a cross-sectional view showing the configuration of the apparatus body of the wearable apparatus according to the second embodiment. FIG. 17 is a block diagram showing an example of the functional configuration of the wearable apparatus according to the second embodiment. The following description of the second embodiment will be primarily made of the forms and configurations of the apparatus body different from those in the first embodiment described above, and the same forms and configurations have the same reference character and will not be described in some cases.

The apparatus body 18, which forms a wearable apparatus 100A according to the second embodiment, includes the case section 30 including the first case member 21 and the second case member 22, as shown in FIGS. 15 and 16. The second case member 22 is located on the side facing a target under measurement when the apparatus body 18 is worn on a user. The first case member 21 is disposed, relative to the second case member 22, on the side opposite the target under measurement (front side). The detection window 221 is provided in the rear surface of the second case member 22, and the biological sensor section 40 is provided in the second case member 22 in a position corresponding to the detection window 221.

The apparatus body 18 includes, in addition to the first case member 21 and the second case member 22, the module substrate 35, the biological sensor section 40 connected to the module substrate 35, the circuit substrate 61, the panel frame 62, the circuit case 64, the liquid crystal display (hereinafter referred to as LCD 501) that forms the display section 50, the acceleration sensor 230 as an example of the body motion sensor, the secondary battery 510, and the GPS antenna 280. It is, however noted that the configuration of the wearable apparatus 100A is not limited to the configuration shown in FIG. 16, and another configuration can be added, and part of the configuration can be omitted. The components described above are the same as those in the first embodiment described above and will not therefore be described in detail in the present embodiment.

The first case member 21 may include the barrel section 211 and the glass plate 212. The ring-shaped wall section 21A, which protrudes toward the front side, and the protruding section 21B, which protrudes inward, are provided in the front-side upper portion of the barrel section 211 of the first case member 21. The glass plate 212 is mounted on the front side of the protruding section 21B and connected and fixed to the inner circumferential surface of the wall section 21A, for example, via the adhesive member 215. In this case, the barrel section 211 and the glass plate 212 may be configured to be used as an outer wall that protects the internal structure and to allow the user to view information displayed on the display section 50, such as the LCD 501, provided immediately below the glass plate 212 via the glass plate 212. That is, in the present embodiment, the LCD 501 may be used to display a variety of pieces of information, such as detected biological information, activity information representing the state of an exercise, or time information, and the displayed information may be presented to the user on the side facing the first case member 21. In the present embodiment, the LCD 501 is so disposed as to be in contact with the rear side of the protruding section 21B. The components described above are the same as those in the first embodiment described above and will not therefore be described in detail in the present embodiment.

A bezel 313 is disposed outside the outer circumference of the glass plate 212 of the first case member and along the outer edge of the glass plate 212. The bezel 313 is a ring-shaped (annular) member that surrounds the glass plate 212 and can be formed of a member made, for example, of stainless steel or brass and having a plated surface.

A ring-shaped touch sensor 550, which is provided between the glass plate 212 and the LCD 501, is disposed along an outer edge portion of the glass plate 212. The touch sensor 550 senses a change in capacitance that occurs, when the user touches the glass plate 212 with a fingertip, in a space between an electrode and the user's body (fingertip) to detect the state of the touch operation. The electrode is so disposed in plurality as to be capable of detecting the movement direction of the finger based, for example, on how the capacitance at the plurality of electrodes changes. The amount of movement of the bezel 313 and the rotation direction thereof (rotational speed as required) can be detected based on the motion of the user's finger (movement direction) sensed with the touch sensor 550, as in the case of the rotary bezel 213 (see FIG. 5) described in the first embodiment. The touch sensor 550 does not necessarily have a ring shape and may have any shape that does not interfere with the display operation performed by the display section 50. The touch sensor 550 may instead be incorporated in the glass plate 212 or disposed on the front surface of the glass plate 212.

The wearable apparatus 100A includes, as the functional configuration thereof, the sensor section 200, the GPS antenna 280, the processing section 300, the input section 390, the notification section 400, the secondary battery 510 as the power supply section, the storage section 520, the button 530, and the communication section 540, as shown in FIG. 17. The components described above are the same as those in the first embodiment described above and will not therefore be described in detail in the present embodiment.

### Display Method Performed by Wearable Apparatus According to Second Embodiment

A display method performed by the wearable apparatus 100A according to the second embodiment will next be described with reference to FIG. 18. FIG. 18 is a flowchart showing the display method performed by the wearable apparatus according to the second embodiment. The following description will be primarily made of steps different from those carried out by the wearable apparatus 100 according to the first embodiment, and the same steps have the same reference character (same step reference character) and will not be described.

The display method performed by the wearable apparatus 100A includes step S110 of inputting target information, step S112 of measuring an activity, step S114 of generating activity information, step S116 of displaying and storing the activity information, step S119 of checking whether the touch sensor 550 has been operated, step S120 of checking the direction in which the touch sensor 550 has been operated (movement direction of finger), and steps S122 and S124 of displaying the activity information at a selected point of time. The display method performed by the wearable apparatus 100A according to the second embodiment differs from the display method performed by the wearable apparatus 100 according to the first embodiment described above in terms of the display switching method. Specifically, the second embodiment differs from the first embodiment in terms of step S119 of checking whether the touch sensor 550 has been operated and step S120 of checking the direction in which the touch sensor 550 has been operated (movement direction of finger). Step S119 of checking whether the touch sensor 550 has been operated and step S120 of checking the direction in which the touch sensor 550 has been operated (movement direction of finger) will be primarily described below. The display aspects of the wearable apparatus 100A can be the same as those in the first embodiment described with reference to FIGS. 10 and 11. Further, the following description of the procedures uses the same reference characters used in the description of the configuration of the exercise assistance system 1000 described above.

In the display method performed by the wearable apparatus 100A according to the second embodiment, step S110 of inputting target information, step S112 of measuring an activity, step S114 of generating activity information, and step S116 of displaying and storing the activity information are carried out. In the steps described above, target information, such as a target lap time, is inputted, the user's activity (exercise) is measured and sensed with the sensors, activity information is generated, the user's generated activity information and data are successively displayed on the display section 50 at a plurality of points of time and successively saved (stored) in the storage section 520, and other types of operation are performed.

The processing section 300 then evaluates whether or not the user has operated the touch sensor 550 (performed touch operation) (step S119). In other words, the processing section 300 evaluates whether or not an operation signal has been outputted in correspondence with the operation of the touch sensor 550 (touch and finger movement). In a case where the result of the evaluation in step S119 shows that the touch sensor 550 has been operated (Yes in S119), the processing section 300 proceeds to the following step and evaluates whether or not the direction in which the touch sensor 550 has been operated (movement direction of finger) is the first direction (step S120). In a case where the result of the evaluation in step S119 shows that the touch sensor 550 has not been operated (No in S119), the processing section 300 returns to the previous step S116.

In a case where the result of the evaluation in step S120 shows that the direction in which the touch sensor 550 has been operated is the first direction (Yes in step S120), the processing section 300 selects a selected point of time in such away that it moves from the second point of time, which follows the first point of time, to the first point of time and displays the activity information at the selected point of time after the selection (step S122). The displayed information in this case (step S122) is the same as that in the display example described with reference to FIGS. 12A to 12C.

In a case where the result of the evaluation in step S120 shows that the direction in which the touch sensor 550 has been operated is not the first direction, that is, the operation direction is the second direction (No in step S120), the processing section 300 selects a selected point of time in such a way that it moves from the first point of time to the second point of time, which follows the first point of time, and displays the activity information at the selected point of time after the selection (step S124). The displayed information in this case (step S124) is the same as that in the display example 2 described with reference to FIGS. 13A to 13C.

As described above, according to the configuration of the wearable apparatus 100A according to the second embodiment and the display method performed thereby, the method for selecting a selected point of time can be readily changed based on the direction in which the touch sensor 550 is operated (movement direction of finger). That is, when the touch sensor 550 is so operated that the finger moves in the first direction, the point of time can be so selected that the selected point of time moves from the second point of time to the first point of time, whereas when the touch sensor 550 is so operated that the finger moves in the second direction, which is opposite the first direction, the point of time can be so selected that the selected point of time moves from the first point of time to the second point of time.

### Variation of Display Method

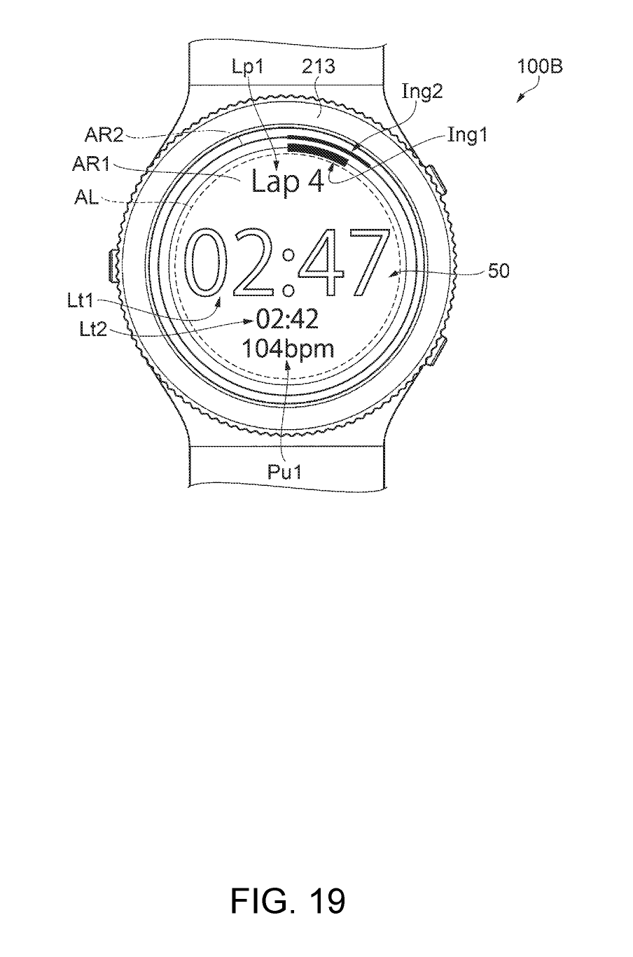

A variation of the display method will next be described with reference to FIG. 19. FIG. 19 is a plan view showing the variation of the display method. In the following description, the same configurations and display method as those in the first embodiment described above have the same reference character and will not be described in some cases.

In the display method according to the present variation, the processing section 300 (data processing section 320) calculates comparison information representing the result of comparison between the target information inputted by the user and the generated activity information at a selected point of time and displays the calculated comparison information on the display section 50 of a wearable apparatus 100B.

In the display method according to the present variation, the display section 50 of the wearable apparatus 100B is divided by the broken line AL shown in FIG. 19 into the first area AR1, which is a central area, and the second area AR2, which is outside the broken line AL (on the side facing the rotary bezel 213), as shown in FIG. 19, as in the first embodiment. The first area AR1 successively displays the user's activity information at the point of time “Lap 4.” In the present example, the first area AR1 displays the following pieces of information: the number of the lap at the point of time is displayed in the upper portion; the lap time at the point of time and the target time are displayed in the central portion; and the average pulse rate at the point of time is displayed in the lower portion. The second area AR2 displays a ring-shaped first indicator Ing1, which displays the activity information at a selected point of time in a visual form, and a ring-shaped second indicator Ing2, which displays the target information at the selected point of time in a visual form.

FIG. 19 shows an example of displayed activity information at the point of time “lap 4” selected as the displayed point of time. In the present example, the first area AR1 of the display section 50 displays the following pieces of information: “Lap 4” is displayed as the number of the lap Lp1 at the point of time (selected point of time) in the upper portion; “02:47 (2 minutes and 47 seconds)” is displayed as the lap time Lt1 at the point of time “Lap 4” in the central portion; and “02:42 (2 minutes and 42 seconds)” as the lap time target value Lt2, which is lap time target information at the point of time “Lap 4,” is further displayed in the central portion and below the lap time Lt1 as the comparison information. The first area AR1 of the display section 50 further displays “104 bpm” as the average pulse rate Pu1 at the point of time “Lap 4” in the lower portion.

In the second area AR2, the two ring-shaped indicators Ing1 and Ing2 are disposed side by side. The first indicator Ing1, which is located closer to the center of the apparatus body, indicates an activity information (lap time) accomplished value as the progress information at the selected point of time “lap 4,” in detail, an accomplished value corresponding to “02:47 (2 minutes and 47 seconds)” as the lap time Lt1 in the form of the length of the ring. The second indicator Ing2, which is located closer to the outer circumference of the apparatus body, is displayed in the form of a ring having a length corresponding to “02:42 (2 minutes and 42 seconds)” as the lap time target value Lt2, which is the target information (target lap time) at the selected point of time. In the present example, the second indicator Ing2 is displayed as the target information at “lap 4,” which is the displayed selected point of time, in the form of a ring extending to the angle corresponding to one turn (360°) multiplied by 4 laps divided by 20 laps.

The target information described above can be set, for example, in any of the patterns described below.

1) Target information is set via the input section 390 of the wearable apparatus 100, 110A, or 100B, as described in the embodiments described above.

2) Target information is set by using an application installed, for example, in a smartphone or a tablet-type terminal device and transmitted to the wearable apparatus 100, 110A, or 100B, for example, via BLE (Bluetooth Low Energy).

3) Target information is set in a PC (personal computer) and transmitted to a server over the network NE and further transmitted from the server or a smartphone, a tablet-type terminal device, or any other device synchronized with the server to the wearable apparatus 100, 110A, or 100B.

Comparing target information with activity information (progress information) and displaying the result of the comparison allow the user to readily check comparison information displayed on the display section 50 and representing the result of the comparison between the target information and the activity information (progress information) at a selected point of time. In other words, the user can check the situation of the user's activity at each selected point of time, that is, the performance of the user's activity, the degree of progress of the activity (progress situation), and other factors, while comparing the situation with the target at the selected point of time.

In the display method in each of the embodiments described above, further efficient display operation can be performed, for example, by setting the following conditions.

A) During a race or an exercise and when the measurement is not terminated or suspended, detection of rotation of the rotary bezel 213 as the bezel section or operation of the touch sensor 550 (touch operation) is not accepted, so that no history information on the activity information is displayed.

The user's wrong operation can thus be avoided.

B) In the middle of a race or a workout, when the measurement is “suspended,” operation of rotating the rotary bezel 213 is accepted, and history information on the activity information is displayed. The “suspended” state may be determined based, for example, on a result of the detection performed by the body motion sensor, the position sensor, or any other sensor or may be set, for example, by the user's button operation.

History information on the activity information can thus be displayed in response to the user's intention.

C) When a race or a workout ends, measurement end operation is accepted from the user, and measured data saving operation (storing operation) is accepted from the user. In a case where the rotary bezel 213 is rotated after the saving operation (storing operation) is accepted, the user is allowed to view history information on the activity information.

A situation in which the user forgets to save data can thus be avoided.

D) The number of types of information that can be displayed after the saving operation (storing operation) is greater than the number of types of information that can be displayed during suspension of a workout.

The wearable apparatus can thus be configured to display only part of the information that the user is interested in during the workout, whereby useless computation performed by the processing section can be avoided.

Further, in the above description, a wrist apparatus worn on the user's wrist has been described as an example of a portable electronic apparatus worn on the user's (wearer's) given site. Instead, the following examples showing how the user wears the wrist apparatus can be presented: For example, the portable electronic apparatus may be a neckless-shaped apparatus worn around the neck; may be worn, for example, on the torso or an ankle; or may be held in the user's pocket or bag, as in the case of a personal digital assistance.

The above description has been made by using a GPS (Global Positioning System) as the satellite positioning system, and another global navigation satellite system (GNSS) may instead be used. For example, one of or two or more of EGNOS (European Geostationary-Satellite Navigation Overlay Service), QZSS (Quasi Zenith Satellite System), GLONASS (GLObal NAvigation Satellite System), GALILEO, BeiDou (BeiDou Navigation Satellite System), and other satellite positioning systems may be used. Further, WAAS (Wide Area Augmentation System), EGNOS (European Geostationary-Satellite Navigation Overlay Service), or any other satellite-based augmentation system (SBAS) may be used as at least one of the satellite positioning systems.

What is claimed is:

1. A wearable apparatus comprising:
at least one sensor that measures a user's activity;
a processor that generates activity information at a plurality of points of time based on data measured with the at least one sensor;
a display that displays the activity information; and
a bezel that is disposed along a circumferential edge of the display and outputs an operation signal corresponding to an operation of the user,
wherein the processor causes the display to display the activity information corresponding to a selected one of the plurality of points of time based on the operation signal.

2. The wearable apparatus according to claim 1,
wherein the processor acquires target information on a target of the user's activity, and
the processor causes the display to display progress information calculated based on the operation signal by using the activity information corresponding to the selected point of time and the target information.

3. The wearable apparatus according to claim 2,
wherein the display has a first area and a second area different from the first area, and
the processor causes the display to display the activity information in the first area and causes the display to display at least one of the progress information and the activity information corresponding to the selected point of time in the second area.

4. The wearable apparatus according to claim 1,
wherein the plurality of points of time correspond to laps in the user's activity.

5. The wearable apparatus according to claim 2,
wherein the processor calculates comparison information on a result of comparison between the target information and the activity information at the selected point of time and causes the display to display the comparison information.

6. The wearable apparatus according to claim 3,
wherein the processor calculates comparison information on a result of comparison between the target information and the activity information at the selected point of time and causes the display to display the comparison information.

7. The wearable apparatus according to claim 3,
wherein the processor adds a note to the activity information and causes the display to display the activity information associated with the note in the first area.

8. The wearable apparatus according to claim 1,
wherein the plurality of points of time include a first point of time and a second point of time that follows the first point of time,
when the bezel is rotated in a first direction, the selected point of time moves from the second point of time to the first point of time, and
when the bezel is rotated in a second direction, which is opposite the first direction, the selected point of time moves from the first point of time to the second point of time.

9. A display method comprising:
generating activity information at a plurality of points of time based on data on a user's activity measured with a sensor of a wearable apparatus; and
causing a display of the wearable apparatus to display the activity information corresponding to a selected one of the plurality of points of time based on an operation signal outputted in correspondence with operation of rotating a bezel of the wearable apparatus.

10. The display method according to claim 9, further comprising:
acquiring target information on a target of the user's activity; and
causing the display to display progress information calculated based on the operation signal by using the activity information corresponding to the selected point of time and the target information.

11. The display method according to claim 9, further comprising:
acquiring a note associated with the activity information; and
causing the display to display the activity information associated with the note in a first area.

12. The display method according to claim 9,
wherein the plurality of points of time include a first point of time and a second point of time that follows the first point of time,
when the bezel is rotated in a first direction, the selected point of time moves from the second point of time to the first point of time, and
when the bezel is rotated in a second direction, which is opposite the first direction, the selected point of time moves from the first point of time to the second point of time.

13. A wearable apparatus comprising:
at least one sensor that measures a user's activity;
a processor that generates activity information at a plurality of points of time based on data measured with the at least one sensor;
a display that displays the activity information; and
a touch sensor that outputs an operation signal corresponding to an operation of the user,
wherein the processor causes the display to display the activity information corresponding to a selected one of the plurality of points of time based on the operation signal.

14. The wearable apparatus according to claim 13,
wherein the processor acquires target information on a target of the user's activity, and
the processor causes the display to display progress information calculated based on the operation signal by using the activity information corresponding to the selected point of time and the target information.

15. The wearable apparatus according to claim 14,
wherein the display has a first area and a second area different from the first area, and
the processor causes the display to display the activity information in the first area and causes the display section to display at least one of the progress information and the activity information corresponding to the selected point of time in the second area.

16. The wearable apparatus according to claim 15,
wherein the processor calculates comparison information on a result of comparison between the target information and the activity information at the selected point of time and causes the display to display the comparison information.

17. The wearable apparatus according to claim 13,
wherein the plurality of points of time correspond to laps in the user's activity.

18. The wearable apparatus according to claim 14,
wherein the processor calculates comparison information on a result of comparison between the target information and the activity information at the selected point of time and causes the display to display the comparison information.

19. The wearable apparatus according to claim 15,
wherein the processor adds a note to the activity information and causes the display to display the activity information associated with the note in the first area.

20. A wristwatch, comprising:
a display;
at least one sensor that measures a user's activity;
a rotary bezel that is disposed along a circumferential edge of the display and outputs an operation signal corresponding to an operation of the user; and
a processor that causes the display to display activity information corresponding to a point of time selected by the operation of the user, the activity information being generated based on data from the at least one sensor.
